(19) United States
(12) Patent Application Publication
(10) Pub. No.: US 2013/0150004 A1
(43) Pub. Date: Jun. 13, 2013

(54) METHOD AND APPARATUS FOR REDUCING MOBILE PHONE USAGE WHILE DRIVING

(71) Applicant: Michael Rosen, Akron, OH (US)

(72) Inventor: Michael Rosen, Akron, OH (US)

(21) Appl. No.: 13/757,583

(22) Filed: Feb. 1, 2013

Related U.S. Application Data
(63) Continuation-in-part of application No. 13/277,990, filed on Oct. 20, 2011.
Application No. 13/277,990 is a continuation-in-part of application No. 12/685,454, filed on Jan. 11, 2010, now Pat. No. 8,384,555.
Application No. 12/685,454 is a continuation-in-part of application No. 11/678,489, filed on Feb. 23, 2007, now Pat. No. 7,646,312.
Application No. 12/685,454 is a continuation-in-part of application No. 12/433,219, filed on Apr. 30, 2009, now Pat. No. 8,131,205.
(60) Provisional application No. 61/594,408, filed on Feb. 3, 2012.
(60) Provisional application No. 61/619,235, filed on Apr. 2, 2012.
(60) Provisional application No. 61/650,078, filed on May 22, 2012.
(60) Provisional application No. 61/675,179, filed on Jul. 24, 2012.
(60) Provisional application No. 60/837,594, filed on Aug. 11, 2006.
(60) Provisional application No. 61/049,610, filed on May 1, 2008.
(60) Provisional application No. 61/175,952, filed on May 6, 2009.
(60) Provisional application No. 61/487,694, filed on May 18, 2011.

(51) Int. Cl. H04W 8/22; H04W 4/16

(52) U.S. Cl. CPC H04W 8/22; H04W 4/16
USPC 455/414.1; 455/422.1; 455/418

(57) ABSTRACT

An apparatus that includes a mobile phone detection system is provided. The detection system includes a processor and a plurality of sensors that are operative to be used by the processor to determine which individuals in a group of individuals are and are not transmitting a predetermined type of RF signals. The sensors include a frequency antenna operative to receive RF signals from locations associated with positions of each respective individual. The sensors include a further sensor that is operative to detect data that is used by the processor to corroborate which individuals in the group are and are not transmitting the predetermined type of RF signal. The detection system is operative to communicate to a remote server, data corresponding to at least a portion of the determination made regarding which of the individuals in the group are and are not transmitting the predetermined type of RF signal.

### BACKGROUND

As mobile telephones (“mobile phones”) have come into widespread use, people often use their mobile phones while driving vehicles. However, mobile phone usage by the driver of a vehicle can significantly distract the driver's attention from driving-related tasks. As result, mobile phone use while driving can significantly increase the risk of traffic violations and driving accidents. Accordingly, it is desirable to provide a system and method which is operative to assist in decreasing traffic violations and driving accidents caused by mobile phone use while driving. It may also be desirable to provide other improvements involving mobile phone usage.

### BRIEF SUMMARY

It is an aspect of at least one embodiment to provide a system and method which is operative to assist in decreasing traffic violations and driving accidents caused by mobile phone use while driving.

The foregoing aspects may be accomplished in at least one embodiment by an apparatus and method operative to detect mobile phone usage (which may include detection of cell phone signals and/or any other wireless signals with which a mobile phone may communicate and/or any other type of usage indicator internal or external to the mobile phone).

An example embodiment may comprise a detection system, including at least one processor and a plurality of sensors that are operative to be used by the at least one processor to determine which individuals in a group of individuals (e.g., drivers of vehicles; people in a room or hallway of a building) are and/or are not transmitting a predetermined type of radio frequency signals (e.g., mobile phone signals, RFID signals, or other radio frequency signals). The sensors may include at least one radio frequency antenna operative to receive radio frequency signals from locations associated with positions of each respective individual. Also in the described embodiment, the sensors may include at least one further sensor (e.g., a camera, presence detector, motion detector, movement detector, and/or velocity detector) that is operative to detect data (e.g., locations, motion, movement, and/or velocity) that is used by the at least one processor to corroborate which individuals in the group are and are not transmitting the predetermined type of radio frequency signals. The detection system may be operative to communicate to at least one remote server, data corresponding to at least a portion of the determination made regarding which of the individuals in the group are and are not transmitting the predetermined type of radio frequency signal. Such data for example may include the number of individuals detected with and/or without an associated mobile phone or other type of radio frequency emitter.

In example embodiments, such a detection device may be located in positions to detect individuals in moving vehicles in a roadway, in buildings, and/or in other locations. In some embodiments, the detection system may be mounted to a portion of a building, tower, pole or other structure. In other embodiments, all or portions of the detection system may be included in a portable hand-held portion capable of being used by law enforcement officers or other users. For example, the portable hand-held portion may include a camera and a radio frequency signal detector that are operative to capture images and radio frequency signals associated with drivers of a vehicles that may and may not be using a mobile phone while driving. In this example, the data acquired by the sensors in the detection system may be used by the at least one processor in the portable hand-held portion to determine in which vehicles a mobile phone is actively being used by the drivers of the vehicles.

To assist in the detection, the portable hand-held portion of the described detection system may include an IR illuminator that is operative to illuminate at least portions of the vehicle with IR illumination capable of being captured by the at least one camera. In further embodiments the detection system may include eyewear. Such eyewear may include a display device mountable adjacent the eyes of an operator of the detection system. The processor in the detection system may be operative to cause the display device of the eyewear to display at least one image captured by the at least one camera of the portable hand-held portion of the system.

Further embodiments described herein may be responsive at least in part to the detection of the usage of the mobile phone, to carry out one or more different actions. Such actions may include reporting the use of the mobile phone to a local or remote server in order to enable one or more further actions to be taken (e.g., issuing a ticket, confiscation of the mobile phone, tracking mobile phone addiction, tracking usage of the mobile phone). Such actions may also include disrupting the usage of the mobile phone in a manner which stops and/or encourages the user from continuing to use the mobile phone. For example, in an example embodiment an apparatus and method may include detecting the user's voice (while talking on the mobile phone) with an audio capture device (e.g., a microphone) and causing an audio output device (e.g., a speaker) to output an audio output (hearable by the user and/or perceptible by the brain of the user) corresponding to the detected user's voice. This described outputted audio output may be delayed by many milliseconds (e.g. 10-100 ms) or other sufficient amount relative to the actual voice of the user to cause the user to discontinue talking and/or using the mobile phone. Such delayed audio output is also referred to herein as delayed auditory feedback and may be generated in example embodiments to discourage use of mobile phones in vehicles as well as to treat addiction to use of mobile phones.

Such a system to generate delayed auditory feedback may be integrated or installed in a vehicle and may be activated when a detected velocity of the vehicle is above a predetermined threshold. In other example embodiments the system to generate delayed auditory feedback may be included in an application installable on a mobile phone.

In another example embodiment of a system that discourages a user from using a mobile phone while drive, one or more applications on a mobile phone may be operative to determine that the mobile phone is moving and prevent one or more features of the application from being used by user while driving the vehicle. In this example, at least one of a plurality of applications installed on the mobile phone (e.g., social media application, a game, a book reader, a communication component of the mobile phone, and/or another application) may be operative to individually query the operating system of the mobile phone to determine whether the mobile phone is likely moving in a vehicle. Responsive to the query, the operating system may be operative to provide a response to the at least one application, which response includes information indicative of whether the mobile phone is moving in a vehicle. This described at least one application may be operatively configured to disable at least one feature of the at least one application from being usable by a user of the mobile phone, responsive at least in part to the response received from the operating system, when such response includes information indicative of the mobile phone moving in a vehicle. Also, the at least one application may be operatively configured to enable the at least one feature of the respective application to be usable by a user of the mobile phone, responsive to the response received from the operating system, when such response includes information not indicative of the mobile phone moving in a vehicle.

An example of a social media application may be a Facebook application or other application that enables a user to operate the mobile phone to receive communications from and to post communications to at least one remote server, which communication are accessible to a plurality of other users through operation of the least one remote server. Such a social media application may differ from other communication features of the mobile phone in that it does not carry out voice communications or text messages with the at least one remote server.

In another example embodiment of a system that discourages users from using a mobile phone while driving, one or more communication components of the mobile phone (which enable communication via voice and/or text messages), may be operative to detect that the mobile phone is moving and report that detection to the user of another mobile phone or device receiving the communication. In this example embodiment, the mobile phone may include at least one application that is operative responsive at least in part to data determined from a global positioning system device in the phone to cause at least one communication component to include a message in a transmitted voice or text message communication (to a second mobile phone). Such a message may convey information indicative of the communication being communicated from a mobile phone that was moving in vehicle.

When such a communication includes a text message, the message included in the text message may include at least one of: text, a symbol, or any combination thereof which conveys that the text message was communicated from a mobile phone that was moving in a vehicle. Also for example, when the communication includes a voice call, the message included in the voice call may include a sound corresponding to at least one of: a verbal warning, a sound indicative of a warning, or any combination thereof, which warning audibly conveys that the voice call involves a mobile phone that is moving in a vehicle.

In a further embodiment related to controlling mobile phones, a mobile phone may include an application that is operative to use the mobile phone to detect a predetermined radio frequency communication. Responsive at least in part to the detection of the radio frequency communication, the application may be operative to cause the mobile phone to change to a mode in which the mobile phone is operative to automatically respond to incoming voice calls or text messages with a reply message indicating that the user is unable to respond at the current time. In this described example embodiment, the at least one application may be configurable to be operative to communicate different corresponding reply messages responsive to detected different radio frequency communications from different radio frequency transmitters. Also the application may be operative to cause the mobile phone to mute incoming message notification sounds responsive at least in part to the detected radio frequency communication.

In a further embodiment related to controlling mobile phones, a mobile phone may include an application that is operative to receive alert messages from a remote server. Such alert messages may be sent to the mobile phone and/or retrieved by the mobile phone from the remote server responsive at least in part to the match between the currently location of the mobile phone and a range of locations associated with the alert message. For example, the remote server may include a data store including both an alert message (such as a warning about a shooting at a school) and data indicating a range of locations in which mobile phones therein should be issued the alert message. Mobile phones with the application located in the range of locations will receive the alert message from the remote server, so as to alert users near and/or traveling to a location associated with the alert message.

Further aspects of embodiments will be made apparent in the following Detailed Description and the appended claims. Also, it is to be understood that the described features and steps described in these examples may be combined with other features and steps described with respect to other embodiments described herein.

### BRIEF DESCRIPTION OF DRAWINGS

FIG. 1 is a flowchart of a method of detecting and prosecuting for illegal use of a mobile phone by a driver.

FIG. 2 is a flowchart as in FIG. 1 additionally including a sensor device operative to detect the velocity of a vehicle that is above a speed limit.

FIG. 3 is a flowchart as in FIG. 1 in which image acquisition is enabled by detection of a mobile phone transmission and is triggered by a sensor such as a vehicle presence detection device.

FIG. 4 illustrates an embodiment of a detection system including a mobile phone signal receiver device and an image capture device.

FIG. 5 illustrates the detection system of FIG. 4, further including a sensor device for measuring the speed of the vehicle.

FIG. 6 illustrates the detection system of FIG. 4 in which signal detection enables or arms the system and a trigger causes image acquisition.

FIG. 7 illustrates a detection system which uses triangulation involving multiple antennas.

FIGS. 8 and 9 illustrate an example detection system that includes an infrared illumination device.

FIGS. 10-15 illustrate digital images captured with and without infrared illumination devices.

FIG. 16 illustrates an example detection system and various optional features of the system.

FIG. 17 illustrates an example detection system mounted in a vehicle that is operative to notify third parties of the use of a mobile phone in the vehicle.

FIG. 18 illustrates an example of a plurality of detection systems mounted in a building such as a prison.

FIG. 19 illustrates a schematic view of an example portable detection system.

FIG. 20 illustrates a schematic view of an example mobile phone.

### DETAILED DESCRIPTION

Cellular (“cell”) telephones are mobile phones which are capable of receiving and making telephone calls wirelessly within a cellular network. Mobile phones may also be capable of sending and/or receiving other content, such as text messages, e-mails, web pages, music, video and other information. Other types of mobile phones include satellite phones which are capable of receiving and making telephone calls wirelessly using one or more orbiting satellites. Also, other types of mobile phones may be capable of sending and receiving communications using wireless networking technology such as WiFi (e.g., IEEE 802.11a, b, g, n, 2012, ac, and/or ad compatible).

Mobile phones may be packaged as handheld devices. Mobile phones may also be integrated into a vehicle or coupled to a vehicle or the driver, such that a driver may make and receive mobile phone calls without holding a portable device. Such devices are often referred to as “hands-free” phones and may include mobile phones integrated into the vehicle, mobile phones connected to the vehicle via wireless technology (e.g., Bluetooth), mobile phones operated remotely through voice commands, and/or mobile phones operated using a headset. As used herein, a mobile phone includes any communication device capable of being used to carry out wireless phone calls, text messages, web browsing and other communications while driving a vehicle. For example, as used herein a mobile phone may include (or be integrated into) communication devices such as laptop computers, PDAs, netbooks, tablets, portable gaming devices, or any other type of device which is capable of communication wirelessly from inside a vehicle or other location.

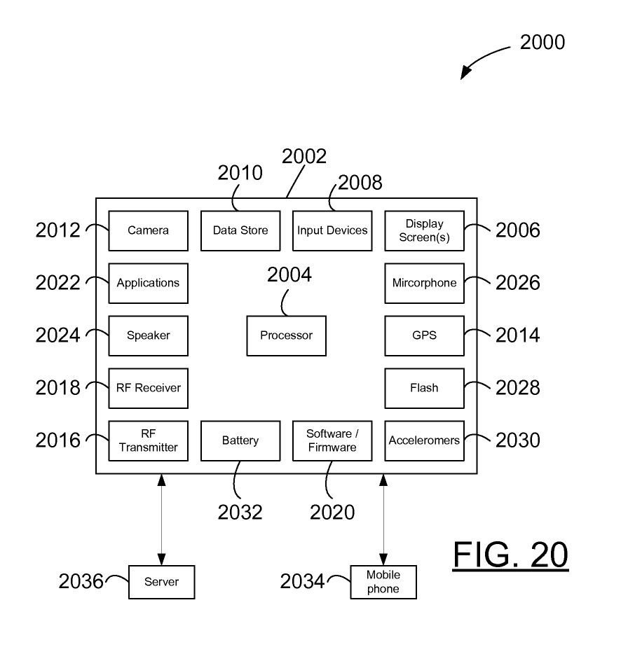

FIG. 20 illustrates an example embodiment 2000 of components that may be included in a mobile phone 2002. Such a mobile phone may include at least one processor 2004, display device 2006, input device 2008, data store 2010, camera 2012, global positioning system (GPS) 2014, radio frequency (RF) transmitter 2016, RF receiver 2018, software/firmware associated with an operating system 2020, software application 2022, audio output device such as a speaker 2024, audio capture device such as a microphone 2026, flash 2028, accelerometer 2030, battery 2032 and/or any other component typically found in a cell phone. It should be appreciated that such a mobile phone may be operative to wirelessly communicate voice communications with other devices such as other mobile phones 2034. Further, such a mobile phone may be operative to wirelessly communicate data with other devices such as a remote server 2036.

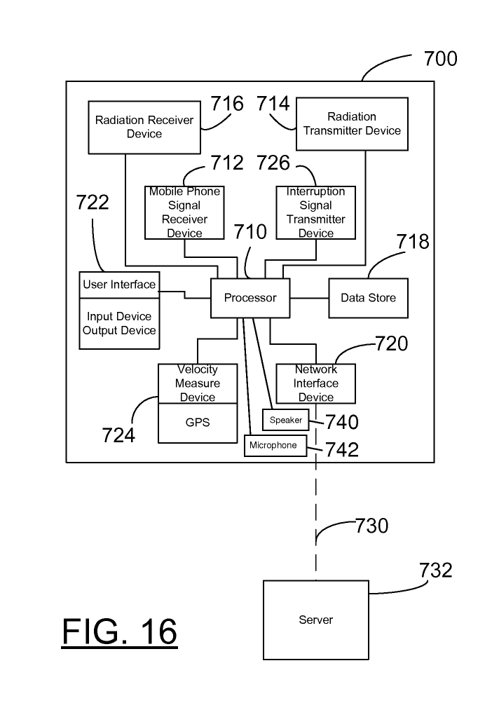

FIG. 16 illustrates an example detection system 700 that is operative to carry out the methods described herein related to detecting mobile phone use in vehicles, roadways, and other locations. As shown in FIG. 16, the detection system may include at least one processor 710. The processor may include software and/or firmware operative to cause the processor to operate one or more of the devices included in the system and to carry out the determinations, functions, and calculations described herein. Such devices may include a mobile phone signal receiver device 712, which as described below in more detail is operative to use one or more antennas to receive mobile phone signals from a mobile phone in a predetermined location. The at least one processor 710 may be operatively programmed to evaluate characteristics of the detected mobile phone signal to determine that the detected at least one mobile phone signal originated from the predetermined location.

In this example, the detection system may include a network interface device 720 that is operative to communicate with at least one remote server 732 through a wired and/or wireless network 730. The at least one processor is operatively programmed to send information to at least one remote server, which information includes data representative of the detection of the at least one mobile phone signal originating from the predetermined location.

In example embodiments, such a remote server may be located geographically away from the roadway, vehicle or other detection area, such as at a facility that receives communications from detection systems located in a plurality of geographically dispersed vehicles, roadways, and/or other locations (e.g. in different locations in a building, road, city, state, country, and/or around the world). However, it should also be appreciated that the remote server may be a data store mounted in spaced part relation with the detection system. A remote server in this context corresponds to a server that is not mounted in the same unit as the detection system but rather is a separate device mounted elsewhere in the same roadway and/or in the same building, complex or vehicle.

For example, such a server may correspond to an event data recorder (EDR) mounted in the vehicle. Both the described detection system and the EDR may be mounted in the same vehicle. The example detection system may be operative to communicate via a wireless or wired connection, data detected and/or determined by the detection system. Such data may include evidence of mobile phone usage by a driver in the vehicle (e.g., talking and/or texting on a mobile phone by a person located in the predetermined location of the driver's seat) which is corroborated by one or more sensors (including one or more RF antennas, microphones, cameras, and/or other sensors) as described herein with respect to the various embodiments discussed herein. For example, data collected by the detection system and communicated to the EDR may include the location of the mobile phone in the vehicle as detected by RF signals, which location may confirm that the driver was using the mobile phone. Also such data communicated to the EDR may include images/video of the driver of the vehicle using the mobile phone captured by a camera. Further, such data communicated to the EDR may include audio of the driver talking on a mobile phone that is captured via a microphone. The data communicated to the EDR may also include information derived from the mobile phone (or other signals) transmitted from the mobile phone, such as mobile phone identification data and/or any other type of data capable of being determined by the detection system regarding the detected mobile phone.

As described below in more detail, some embodiments of the detection system may include a radiation transmitter device 714 (e.g., an infrared light illuminator) operative to transmit radiation such as non-visible radiation (e.g., infrared light) toward the predetermined location. Also, as described below in more detail, in such embodiments the system may also include at least one radiation receiver device 716 (e.g., an image capture device such as a still or video camera) that is operative to receive portions of the radiation after the portions of the radiation have reflected off of matter inside and outside a vehicle.

In addition, as described below in more detail, some embodiments of the detection system 700 may include at least one data store 718, a user interface 722, a velocity measure device 724, and/or an interruption signal transmitter device 726 (also referred to herein as a blocking device). The data store 718 may correspond to a memory device operative to store software, configurable information, images, logs, and another data generated by or used by the at least one processor and other devices in the detection system. The user interface 722 may include one or more input devices and output devices through which a user may configure and operate the detection system. As discussed below in more detail, the velocity measure device 724 may include a device that is capable of determining the velocity of a vehicle remotely (through images from a camera, laser/radar detector, etc.) or may include a device that is capable of determining the velocity of the vehicle while mounted in the moving vehicle (e.g., a GPS).

The interruption signal transmitter device 726 is operative to generate an RF signal capable of stopping or at least degrading a voice communication call or other communication being carried out through a detected mobile phone signal. Such an RF signal may have a frequency and/or may include information which degrades the ability of the RF receiver in the mobile phone to acquire a mobile phone signal from a cell tower for use with carrying out communications with the mobile phone. In another embodiment, the RF signal may have sufficient power to modify the electrical characteristics of the antenna of the mobile phone in a manner that prevents or degrades the ability of the antenna to pick up an RF signal from a cell tower.

In some example embodiments, the user interface 722 of the system may include one or more output devices. Such output devices may be operative to emit audible sounds, visible lights, and/or human perceptible signals corresponding to an alarm, warning, or other message, which indicates that mobile phone use has been detected (and should be discontinued).

For example, one or more of the embodiments described herein may be used to provide delayed auditory feedback (DAF) to a user of a mobile phone in order to discourage use of the mobile phone and/or to treat addiction to use of the mobile phone. To carry out such delayed auditory feedback, the described system may include at least one microphone 742 operative to capture a voice of user of a mobile phone. The system may also include one or more audio output devices (e.g., speakers) 740 through which the processor 710 is operative to cause to output a delayed auditory output of the person's voice captured with the microphone 742. Such a delayed auditory output from the speaker may be operative to interfere with the ability of the user to speak clearly (or at all) and thus may discourage use of the mobile phone.

Although the detection system 700 has been described as including these various devices, it is to be understood that not all embodiments may include each of these devices. Rather, as explained below in more detail, different embodiments may include different sets of these devices, depending on the particular functions needed for the detection system.

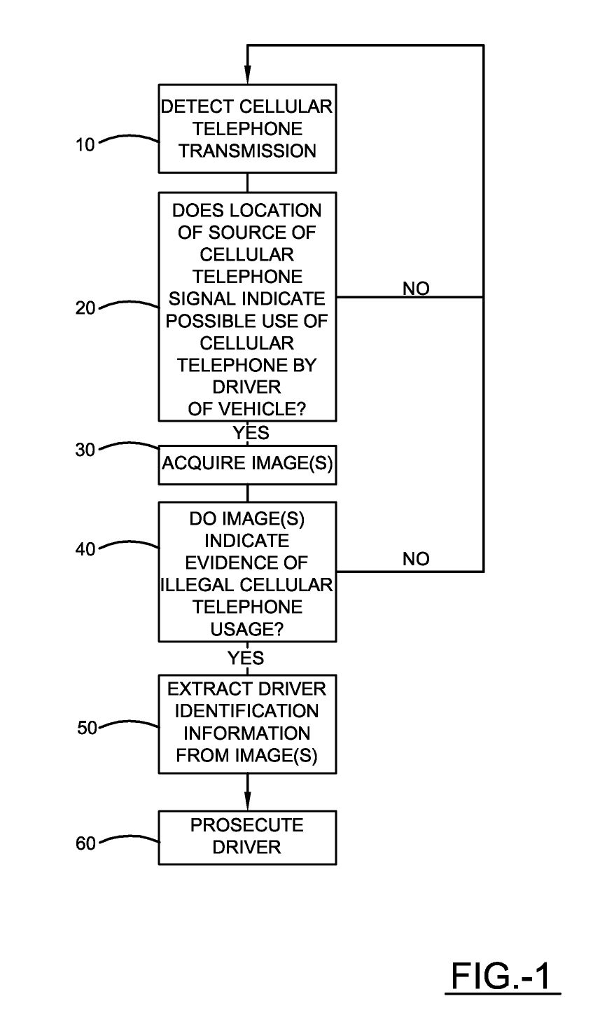

For example, some states and other jurisdictions have passed legislation to forbid drivers from using hand-held mobile phones while driving. Other jurisdictions may forbid all mobile phone use while driving, including the use of hands-free phones. An example embodiment of the detection system includes a method of acquiring information leading to the detection and documentation of illegal mobile phone usage by a driver of a vehicle. This method is illustrated in the flowchart in FIG. 1.

A first step 10 in the method may include detecting a transmission from a mobile phone. A second step 20 in the method may include carrying out an evaluation of the signal to determine whether the signal indicates possible use of a mobile phone by a driver (or other person) in a vehicle. This evaluation may comprise identifying a geographic location of the source of the mobile phone signal transmission, and determining whether that location corresponds or potentially corresponds to a predetermined location within the physical bounds of a roadway.

If the source of a mobile phone signal transmission does not correspond, or likely does not correspond, to a predetermined location within the physical space of a roadway, then no further action need be taken, and in that event, listening for and detection of appropriate transmission signals can continue. If there is detection of a mobile phone signal transmission which originates or is likely to have originated within the physical boundaries of a roadway, this can initiate or permit further action which can comprise the acquisition of image data and/or other sensors.

The detection of a mobile phone transmission can comprise operating a mobile phone signal receiver device which may be tuned to detect signals at appropriate frequencies of the electromagnetic spectrum which is characteristic of mobile telephony usage. In current mobile telephony technology, there are several commonly used signal protocols and signal frequencies. Signal frequencies used for cellular and data transmissions include 900 MHz, 1.8 GHz and 2.1 GHz. Protocols include frequency division multiple access (FDMA), code division multiple access (CDMA); wideband CDMA; Universal Mobile Telephone System (UMTS); and time division multiple access TDMA such as GSM (Global System for Mobile Communications). Other protocols include satellite telephone, Wi-Fi, analog cellular services (AMPS, or Advanced Mobile Phone Service) and GPRS for cellular data services, which could carry voice via Voice Over Internet Protocol; and WiMAX. Also, other protocols and wireless frequencies exist and are continually being developed. As used herein a mobile phone signal is defined as any type of wireless RF signal through which a mobile phone (or other wireless device such as a tablet, laptop, or a communication device integrated into a vehicle) may wirelessly and remotely communicate voice, short message service (SMS) text messages, multimedia messaging service (MMS) messages, and/or data (TCP/IP network communications, or other digital information).

Any particular protocol may have associated with it, its own transmission frequency and its own standard source strength. The source strength of the mobile phone signal transmission may be relevant for establishing a relationship between the signal strength received at the receiver and the distance between the transmitter and the receiver. It is possible that detected signal strength may be used as an indicator of how close the transmitting mobile phone is to the receiver, through the use of a known relationship between signal strength and distance. Because of the differences among the various protocols, such a relationship may be unique to a particular frequency band which is being monitored. There may be one relationship for one frequency and a different relationship for a different frequency.

In appropriate situations, the method may include a step 30 of acquiring images of the vehicle in the form of still images or video or both using an image capture device such as a camera. Such images may be acquired from one camera or vantage point or from more than one camera or vantage point, as discussed elsewhere herein. At least some of the images may depict the driver and the portion of the vehicle in the region of the driver. At least some of the images may comprise sufficient detail to enable visual evaluation and decision-making about the existence of illegal mobile phone usage, as described elsewhere herein. The images, or other information acquired at the same time as the images, may be suitable to identify exactly where in the roadway the vehicle was when the images were taken, and to establish the existence of illegal mobile phone usage.

Acquiring images may further comprise acquiring other information which may be associated with those images, such as the time when the images are acquired and the location where the data is taken. Also, at least some of the acquired images may be suitable for identifying the vehicle or its driver, typically by acquiring an image of the vehicle's license plate. Any or all of this image acquisition may continue for a predetermined duration of time after the start of image acquisition, and then may cease.

In addition, other information associated with the vehicle may also be acquired by one or more sensor devices. For example, a sensor device may include a vehicle velocity measuring device such as a radar or laser gun capable of detecting the velocity of the vehicle. Such a vehicle velocity measure device may be located in a different location than the cameras. In other embodiments, the road adjacent the mobile phone signal receiver devices may include other types of sensor devices, such as a vehicle presence detection device. A vehicle presence detection device may include mechanical sensors which are activated by the weight of the vehicle. Such a vehicle presence detection device may also include optical, electromagnetic and ultrasonic proximity detection sensors. Also, it is to be understood that one or more image capture devices may correspond to the presence detection device. In example embodiments, the captured images and any other acquired information regarding the speed and/or position in time of the vehicle may be stored for later access to enable the system, law enforcement personnel, or other users to decide whether a law has been violated.

According to the details of current legislation in various jurisdictions, transmission of a mobile phone signal from within the physical boundaries of a roadway may indicate but does not necessarily indicate activity which is legally prohibited. There are several possibilities, as follows. One possibility is that a passenger in a vehicle, rather than the driver, may be using a mobile phone. Presumably this may be legal in many jurisdictions. Another possibility would be that the vehicle driver is using a hand-held mobile phone while driving. If there is any form of mobile phone usage which is illegal in a particular jurisdiction, most likely it is this activity which would be illegal. (However, in the event that traffic in the particular roadway was at a standstill or the vehicle was on the shoulder of the roadway, such usage would presumably be legal). Yet another possibility is that the driver might be engaged in a mobile phone conversation using a hands-free apparatus while driving. In some jurisdictions this action may be legal even if those same jurisdictions forbid use of a hand-held mobile phone by the driver. In other jurisdictions, use of a mobile phone by a passenger while the car is moving may be legal, while in other jurisdictions it may not be legal for the passenger to use the mobile phone while the car is moving.

An embodiment of the described method may include a method step 40 of evaluating the images and other acquired data to make a determination as to whether a law has been violated with respect to the particular mobile phone call detected. For example, image analysis may be used to determine if the car is moving during the time period that mobile phone use was detected. Further, the location of the vehicle in the images or the location detected by positional sensors in the road could be correlated with the features of the signals to verify that the particular vehicle being imaged corresponds to the vehicle from which cellular signals are emitting. In addition, a velocity captured for the vehicle may be compared to features of the mobile phone signals to verify that the vehicle being monitored is the correct vehicle from which mobile phone signals are being detected.

For example, the rise and fall of the signal strength of the mobile phone as the car moves toward and then away from an antenna of a mobile phone signal receiver device may be evaluated to determine a velocity of the mobile phone device. Such velocity information determined from the mobile phone signal may be compared to the velocity information determined from image data and/or a vehicle velocity measure device. Correlation between the velocity information determined from the mobile phone and the velocity information determined from image data and/or other vehicle velocity measure devices may be used by the system to determine that the vehicle being imaged corresponds to the source of the mobile phone signals. Also, the system may verify that the position of the vehicle at the peak signal strength for the mobile phone signal corresponds to the vehicle being at its closest position relative to the mobile phone detection sensor.

In further embodiments, the system may include image processing capabilities which are operative to determine whether the driver or passenger is holding a mobile phone. Further, such image analysis may determine if a passenger is present in the vehicle. In embodiments of the method, one or more of these described determinations, correlations, and verifications may be carried out to determine if there is evidence that illegal mobile phone usage is taking place in a particular moving vehicle.

In some embodiments, although one or more of these described determinations, correlations, and verifications may be carried out through operation of a computer processor in the system, it is also to be understood that one or more determinations may be carried out manually. For example, the system may make available one or more of the captured images, video, positional data, velocity data, signal strength data, and/or any other data captured by the system associated with an event. Law enforcement personnel or other users may view recorded images and may visually determine whether particular images show evidence of illegal mobile phone usage (such as use of a hand-held mobile phone) by a driver of a vehicle. If examination of images and/or other captured data indicates violation of a law by the driver (or passenger) of the vehicle, then the method may include the further step 50 of extracting information from images which can be used to automatically determine through operation of a computer and/or manually determine the identity of the vehicle or driver or both, such as from the license plate of the vehicle. In further embodiments, the system may include one or more cameras positioned to specifically capture license plate information from the front and/or the back of a vehicle.

In addition, the method may include a step 60 of initiating the prosecution of the offender for illegal mobile phone usage. For purposes of prosecution, the images may be suitable to serve as evidence which can be used during prosecution of the offender. In an example embodiment, the system may be operative to save in a local data store (and/or a data store associated with a remote server) one or more records corresponding to the event of the mobile phone usage. Such records may include the time, location and all or portions of the data captured for the event.

To initiate the prosecution, the system may be capable of facilitating the mailing of notices in the form of traffic tickets to the owner of the vehicles. Such notices may include a printed copy of the image(s) showing the illegal mobile phone usage, the license of the vehicle, and/or any other evidence captured by the system. Such tickets may include relevant information associated with how to pay the appropriate fine and/or the date to appear before a local court responsible for prosecuting the traffic violation.

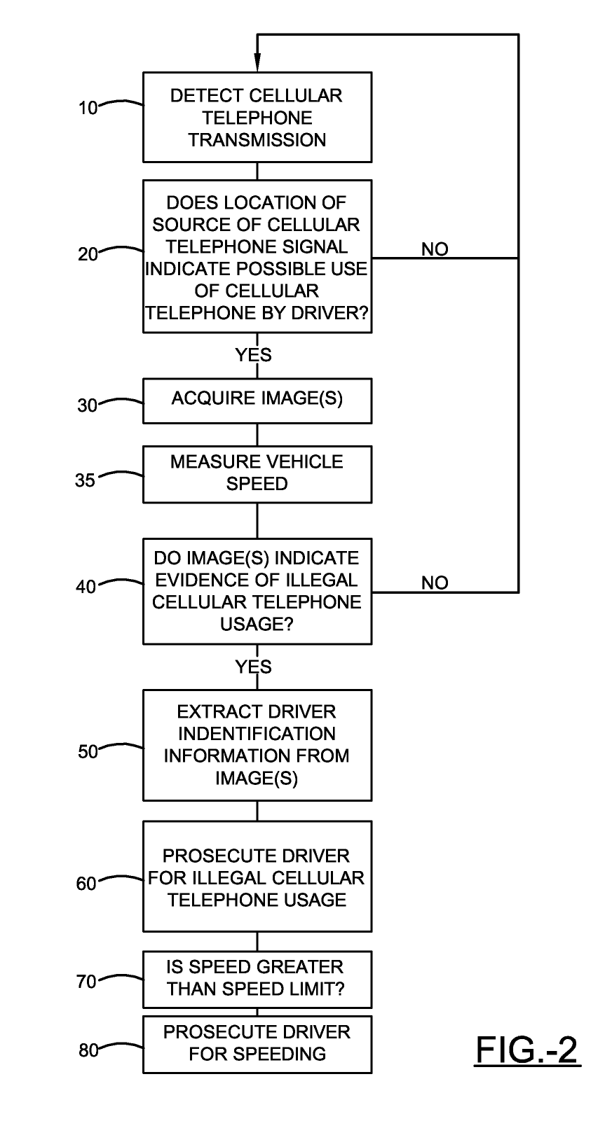

Also, it is to be understood that the example described with respect to FIG. 1 is one of many variations of the method steps that may be carried out to determine that a particular vehicle is the source of illegal mobile phone use. For example, FIG. 2 shows an alternative embodiment. Here the method comprises a step 35 of measuring the velocity of the vehicle in addition to capturing images of the vehicle. The method may include a further step 70 of determining whether a speeding violation has been committed, responsive to the velocity of the vehicle detected and the speed limit for the section of the road being monitored by the system. In addition to prosecuting the driver for illegal mobile phone usage, the method may also include at step 80 prosecuting the driver for exceeding the speed limit. Some of the same information acquired, such as license plate information, could be used for both prosecutions.

It is to be understood that in alternative embodiments, it may also be possible to perform a similar set of combined data acquisition (mobile phone usage and speeding) but to execute decision-making steps in a different order; namely, to first detect speeding violations, and then, for those vehicles for which a speeding violation is detected, examine for illegal mobile phone usage.

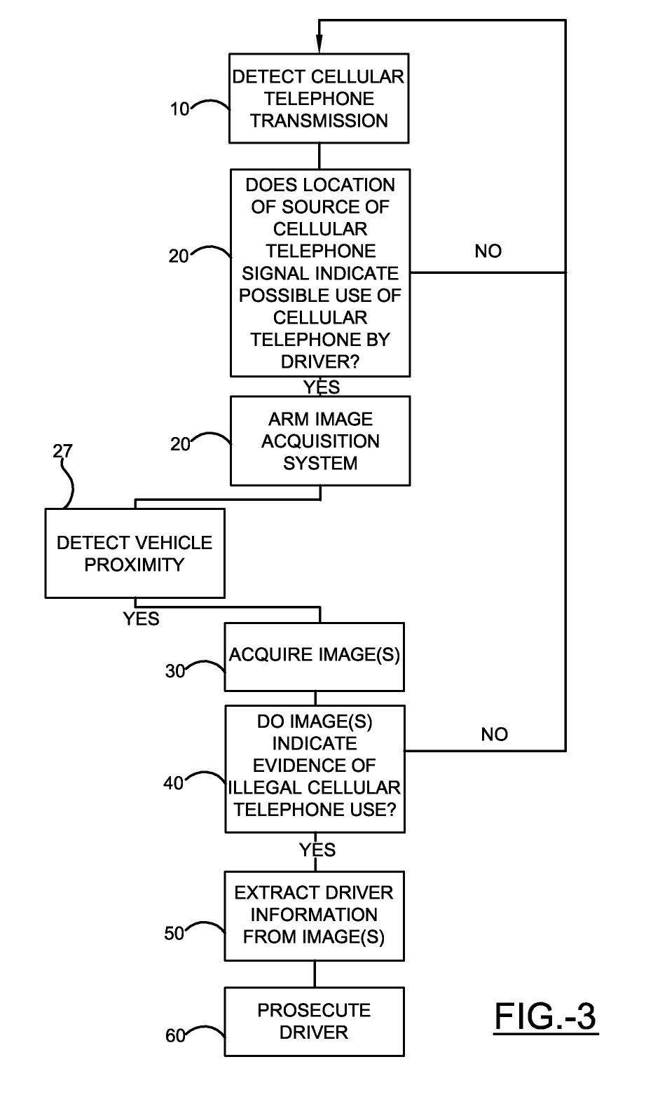

A further alternative embodiment of a method for detecting illegal mobile phone usage is shown in FIG. 3. It can be appreciated that the methods already described and illustrated with respect to FIGS. 1 and 2 may include many images acquired during an event that may not be useful for purposes of identifying illegal mobile phone usage. To enhance the efficiency of the system, the system may be operative to acquire images which can be used to more easily discern whether a driver is illegally holding a mobile phone while driving. As shown in FIG. 3, the method may include a further step 25 of arming the image capture device(s) of the system, responsive to the detection of an appropriate mobile phone signal. Before image acquisition takes place, the method may include a step 27 of detecting and evaluating data from other sensor devices, such as a vehicle presence detection device to determine when the car is properly positioned for image capture. When the vehicle presence detection device indicates that the car is located in a predetermined location, the system may then trigger the step 30 of acquiring images. In this described embodiment, the predetermined location may include a location that enables one or more cameras to acquire detailed images of the driver from the front and/or side of the vehicle. The method may further comprise acquiring more than one image at least approximately simultaneously, such as one image depicting the driver and another image depicting a license plate of the vehicle (or images depicting both license plates of the vehicle).

In an embodiment where the presence detection device corresponds to an image capture device such as a video camera, software operating in one or more computers may be operative to determine the location information for the location of the vehicle from the images acquired by the image capture device. The location information may be used to trigger when further image capture devices are operated to capture images of the drive of the vehicle. Also, the location information may be correlated by the system with the mobile phone signals to determine that the vehicle (the presence of which is detected and the image of which is being captured) is in (or was in) a location that corresponds to the location for the source of mobile phone signals.

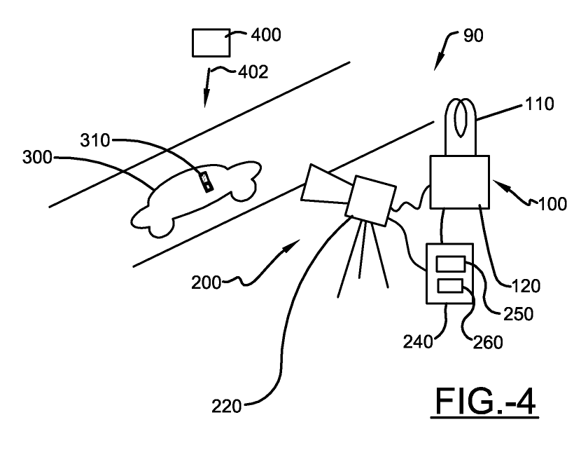

An embodiment may also comprise an apparatus such as a detection system 90 suitable to perform the described method steps. Such a detection system is illustrated in FIG. 4. The detection system may comprise at least one mobile phone signal receiver device 100 which may comprise at least one antenna 110 in operative connection with at least one receiver 120. The antenna 110 may be suitable to receive signals transmitted from a mobile phone 310 such as a cellular telephone in the vehicle 300. The receiver 120 may be tuned or may comprise a filter which is capable of detecting signals whose carrier frequency corresponds to at least one typical mobile phone signal transmission. For example, for common cellular telephone technology, the carrier frequency being monitored may be chosen to be approximately 900 MHz or 1.8 GHz and/or 2.1 GHz.

The described system may use the signal strength of a signal at the selected carrier frequency, as an indicator of distance between the transmitting mobile phone 310 and receiving antenna 110. As discussed elsewhere herein, the antenna 110 may be an antenna which is only able to receive signals which are fairly strong; i.e., signals having a strength which corresponds to a typical cellular telephone transmitter being located within a known, fairly short distance from the antenna 110. Such an antenna would ordinarily be considered a poorly designed antenna, but may be appropriate for use with the described embodiments to avoid detecting mobile phone usage outside the desired detection area. Alternatively, the antenna 110 may be a better-designed antenna with better capability for receiving transmitted signals, and the received signals may be provided to receiver 120, but receiver 120 may comprise a threshold detector such that signals below a predetermined strength are ignored. Signals received by antenna 110 may then enter the receiver 120 where they can be amplified, analyzed, recorded or otherwise processed for purposes of the embodiments described herein.

An embodiment of the detection system may further comprise an image acquisition system 200 which may comprise at least one image capture device 220. Examples of an image capture device include a still camera, video camera, or any other device operative to capture a visual image of at least portions of the vehicle. In an exemplary embodiment, the image capture device may include the capability of generating digital images. However, it is to be understood that the image capture device may also be capable of producing an analog signal corresponding to the captured image or video. In such cases, the image acquiring system 200 may further include a frame grabber board, video capture board, or other image conversion device that is operative to convert analog imaging signals into digital images. However, as discussed below, such an image conversion device may be included in other elements of the detection system.

The image acquisition system and/or one or more image capture devices may be commanded or armed to operate upon receipt of a command from receiver 120 (or a computer associated with the receiver), which command indicates that possibly illegal mobile phone transmissions are emanating from a location in or near the roadway. In exemplary embodiments, the image acquisition system 200 may comprise more than one image capture device, for example pointed in different directions and operative to image the vehicle from different vantage points to capture pictures or video of the driver region of the vehicle and/or the front and rear license plate areas of the vehicle. For example, the system may include a first video camera orientated to capture images from the side of the driver of the vehicle, while a second video camera is orientated to capture images of the front of the vehicle, while a third video camera is orientated to capture images of the back of the vehicle. With this arrangement, the three video cameras may capture images of the driver, the rear license plate, and the front license plate (if present).

In addition, the image acquisition system may include image capture devices operative to acquire images both from a vantage point somewhat to the left of the driver and a vantage point somewhat to the right of the driver, so as to be useful in detecting either a mobile phone held in the driver's left hand or a mobile phone held in the driver's right hand. Alternatively, an image capture device may be oriented to acquire only one such image. For example, the image capture device may be oriented such as to acquire an image obtained from a vantage point sufficiently close to straight in front of the driver so that the image could be used to detect the presence of a mobile phone in either hand of the driver.

In embodiments of the system, the image capture devices may be capable of acquiring images of a vehicle with sufficient resolution to determine and document the license plate or other identifying information about the vehicle or to document in sufficient detail what, if anything, the driver is holding. Also, the image acquisition system may be capable of acquiring more than one image over time pertaining to a particular possible violation event and may be capable of acquiring more than one image from more than one vantage point over time, such as any combination of front, rear and/or side image and/or images at different angles captured over several seconds or longer.

In addition to the captured images of the vehicle, the detection system may also be operative to acquire (and store in association with the images) other desired information about when and where the image was acquired, or any other information of interest. The information about where the images were taken could come from a global positioning system which is part of the detection system. Alternatively, the information could be entered or programmed into the system at the time the system is set up or installed in a particular location. In addition, the detection may also be operative to store (in association with the images) information from or about the mobile phone signal associated with the event. For example, the stored mobile phone signal information may include determined characteristics of the mobile phone signals, such as its strength. Also, the stored mobile phone signal information may include data included in the signal such as data which identifies the mobile phone device, a telephone number, carrier, data identifying the cellular telephone towers involved in communicating with the device, and/or any other data that can be determined from the mobile phone signal.

Mobile phone signals may include an encrypted portion. Some embodiments of the system may be operative to decrypt the signals and/or may be operative to communicate with servers which are operative to decrypt the signal and return decrypted data included in the mobile phone signal. In embodiments of the system that do not have the ability to determine the content of encrypted portions of the mobile phone signal, the system may still be operative to store a copy of the signal. Such a stored copy of the mobile phone signal for an event may be made available for use in prosecuting a person for illegal use of a mobile phone. At the time of the prosecution, the stored mobile phone signal may be retrieved from the data store and decrypted by the entity (e.g., mobile phone service) responsible for establishing the encrypted communication with the mobile phone.

During prosecution of an offender, the system may be operative to carry out or assist in carrying out correlation of the information about where and when the mobile phone signal was detected by the detection system, with information in the offender's mobile phone signal. In addition, the system may be capable of interfacing with mobile phone services to retrieve records corresponding to the particular telephone call carried out with the detected mobile phone signals. Such records may include further details of the call, such as the telephone numbers involved, the duration of the call, global positioning information associated with the location of the mobile phone at the time of the call, and/or any other information stored by the mobile phone service which facilitated the mobile phone call for the mobile phone detected by the system.

In embodiments in which the system is not capable of automatically interfacing with a mobile phone service to retrieve such telephone call records, the system may be operative to output information for law enforcement which may be used to request the relevant telephone call records from the appropriate mobile phone network.

In an embodiment, the system may further comprise a timer or clock whose time information is associated with the other information acquired. This time information may be incorporated into the images. The system may further associate or stamp acquired images with information about where the images were taken. The system may also be operative to digitally sign and/or digitally time stamp images and/or other acquired data regarding an event.

As shown in FIG. 4, the detection system 90 may further comprise at least one storage system 240 (i.e., a data store) capable of storing the mobile phone signals, images, and other acquired information for an event. Such a storage system may include a computer 250 and one or more storage devices 260 such as a hard drive, flash memory drive, tape system, or any other device capable of storing the acquired information for an event. Also, all or portions of the data for each event may be stored in one or more records of a data store such as a database managed by the computer and stored on the storage device or stored in a remote server in operative connection with the computer.

The computer associated with the described storage system may also be operative to control operation of portions of the image acquisition system 200, such as the image capture devices 220. The computer of the storage system may further be operative to control operation of the receivers 120. However, it is to be understood that the detection system may include a computer that is physically separate from the storage system 240, which computer is operative to interface and control the one or more of the components of the described detection system.

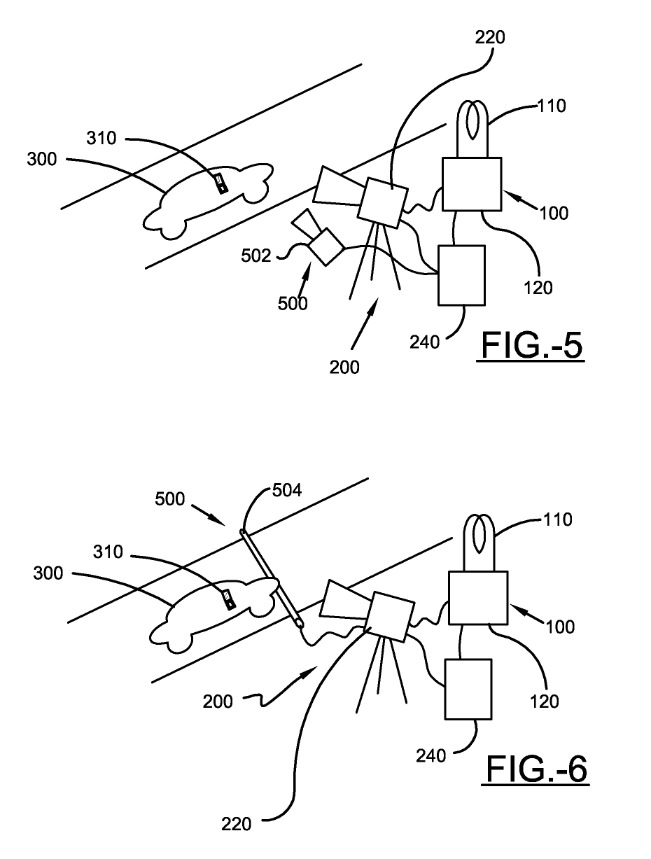

As discussed previously, in addition to capturing images of the vehicle associated with mobile phone signals, the system may include one or more sensor devices operative to acquire other features of the vehicle. For example, as shown in FIG. 5, the system may include a sensor device 500 in the form of a vehicle velocity measure device 502. Another example of sensor devices which the system may include is a vehicle presence detection device such as motion detection devices, proximity detection devices, vehicle position sensing devices, and/or one or more image capture devices. Also, it is to be understood that the system may include any other type of sensor device capable of capturing data regarding the location, speed, identity, or any other information which may be useful for correlating a mobile phone signal with a particular vehicle and/or which may be useful with prosecuting an offender. As discussed previously, information acquired from such sensor devices 500 may be stored for the event by the storage system 240.

As discussed previously, an embodiment may further be operative to enable or arm the triggering of the image acquisition system. This further variation of the detection system is illustrated in FIG. 6. In this example, receipt of a mobile phone signal transmission by the receiver 120 would enable or arm the image acquisition system 200. FIG. 6 shows the addition of a sensor device 500 that is operative to trigger acquisition of images by the image acquisition system after the acquisition of images has been enabled or armed. Here, the sensor device 500 may be in the form of a vehicle presence detection device 504. Such a vehicle presence detection device may include a sensor strung across the roadway which registers when the force of a vehicle's tire is exerted thereon, or could be a sensor which detects the presence of a vehicle by the breaking of a beam of light, or it could be a sensor which detects the metal of a vehicle, or it could be a sensor which detects changes in capacitance caused by the vehicle, or it could be any other appropriate type of sensor operative to detect the presence or position of the vehicle. Also, as discussed previously, the sensor could correspond to an image capture device such as a video camera. Output from this sensor could serve as a trigger for image acquisition by the image acquisition system of images of the drive, license plate, or other portions of the vehicle. Image acquisition could occur or begin either immediately upon receipt of a trigger from such a sensor device 504, or could occur or begin after a known time delay after receipt of a trigger from such a sensor device 504.

In a further embodiment, the system may continually acquire video images from each image capture device which are stored in a respective buffer in a frame grabber and/or in the storage system 240. The buffer may be repeatedly overwritten with newly captured images. However, responsive to the detection of the vehicle by the sensor device 500, and/or responsive to the detection of a mobile phone signal by the signal receiver device 100, the system may be operative to begin storing portions of the buffer in a storage location outside the buffer. In an embodiment, the system may be configurable to enable selection of which images before and/or after a triggering event that should be copied and saved from the buffer. For example, upon detection of the presence of the vehicle and/or the presence of a mobile phone signal, the system may be operative to save from the buffer a pre-selected number of video frames both before and after the triggered event to a portion of the storage system 240. Also, rather than or in addition to selecting the number of frames, the system may be configurable to set the time duration before and/or after a triggered event to save frames from the buffer. The saved images may be stored in the storage system in association with any other data captured for the event.

In a further embodiment, image recording could be done on a continuous basis, and all of the images could be stored or retained. The receipt of a signal from a mobile phone or any other triggering device could cause the detection system to flag the relevant images by storing the time of the detection in the storage device. The system may alert or at least report to law enforcement that triggering events have occurred which may correspond to illegal mobile phone usage. The appropriate portions of the stored video corresponding to the times recorded by the system for an event may later be reviewed by law enforcement personnel to determine if an illegal mobile phone usage can be prosecuted. Also, it is to be understood that in some embodiments, one or more of the described image capture devices may be used by the system to carry out one or more of the previously described functions of the sensor devices 500.

In some embodiments, it is further possible that the detection system may generate reports which are relevant to use of the equipment in an unattended manner. In some embodiments, the detection system may report back to a remote server at a monitoring station (which may be a police facility or other location) any occurrence of possible illegal mobile phone usage and the associated images captured by the system. In some embodiments, the detection system may report back when its capacity for acquiring images is full or nearly full. In some embodiments, the detection system may store its acquired images and other information internally and/or may communicate such information to a remote server, either wirelessly or through wires, either at the time of acquisition of such information or upon the command to transmit such information. In embodiments, the detection system may transmit, either continuously or upon query, information about the status of the detection system. In embodiments, the detection system may comprise a display or lights suitable to display information about the status of the detection system. The detection system may comprise keypads, pointer devices or similar input features. The detection system may comprise an image display suitable to display acquired images. The detection system may comprise interfaces for connecting other systems such as for downloading acquired images and information from the detection system, or for loading instructions into the detection system.

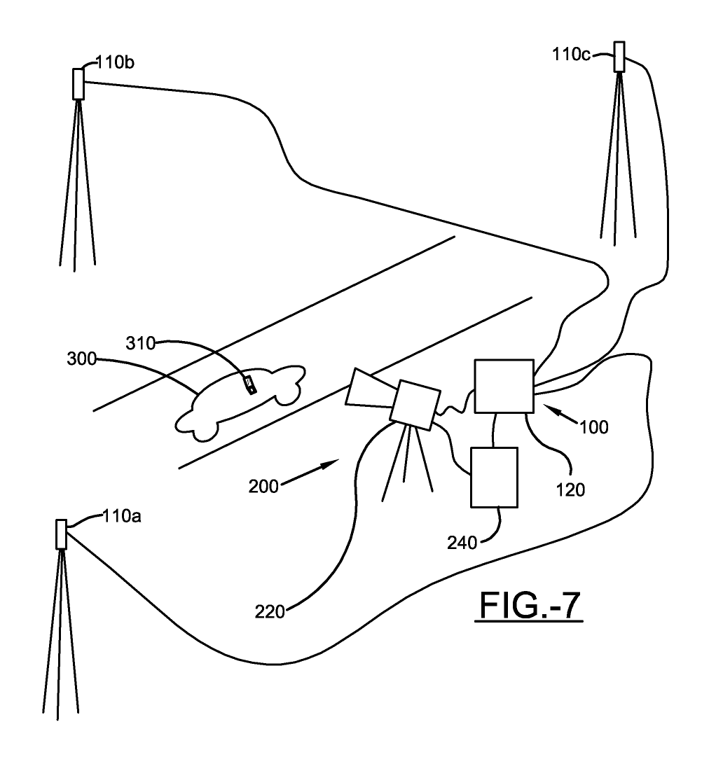

FIG. 7 illustrates a further embodiment of the system. In general, location of a transmitter can be determined by triangulation if a signal is transmitted from one location to three or more receivers at known locations (or, for signal transmission in the opposite direction, if a signal is transmitted to one location from three or more transmitters at known locations). Frequently a cellular mobile phone may be in contact with more than one cellular receiver such as a cellular telephone tower. The arrival times of signals at each of the receivers could be used to determine the position of the transmitting mobile phone, and then to determine whether the transmitting mobile phone is or is likely to be within the physical bounds of a roadway. The relative signal strengths may also enter into such a determination. FIG. 7 illustrates that three antennas 110a, 110b and 110c may be connected to one or more receivers 120. Signals from the three antennas may be used by the detection system to determine that the location from which mobile phone signal transmission is emanating corresponds to the portion of the roadway being monitored by the system. Other aspects of this embodiment can be carried out as described elsewhere herein. In a further embodiment, two antennas may provide some information about possible locations of a mobile phone signal transmission, especially if there are only a limited number of roads or likely locations. Also, changes over to time, in the signal strength or other characteristics of the received signal, can be interpreted to indicate whether the source of the signals is moving and is likely located in the roadway being monitored.

As shown in FIG. 4, in a further embodiment, the system may include a transmitter device 400 capable of communicating the presence of the jurisdiction in which mobile phone usage while driving is prohibited. The transmitter device may be positioned to continuously broadcast a warning signal 402 near the described system or elsewhere in the jurisdiction, such as adjacent a major road entering the jurisdiction. Such a warning signal may include a warning message. In an embodiment, the warning signal may be capable of interrupting an ongoing mobile phone call and cause the mobile phone device to output the warning message. An example warning message may include the verbal output of “Mobile phone usage while driving in this city is prohibited” or other suitable warning.

In an embodiment, the system may be operative to detect or determine the mobile phone number associated with the detected mobile phone signal. Using this determined number, the system may be operative to contact the mobile phone and communicate the warning either verbally or through an SMS message or other communication feature of the device. Also, the system may be operative to transmit other types of information to the mobile phone system based on the determined number of the mobile phone (e.g. advertisements, traffic information, or any other information).

In an alternative embodiment, the mobile phone may be adapted to include the capability of monitoring for warning signals. For example, manufacturers of mobile phones may include in the phone a sensor operative to detect a standardized warning signal and responsive thereto to emit an audible warning sound or verbal message.

In an alternative embodiment, rather than providing a warning, the system may contact the determined mobile phone number and communicate information regarding the violation of the law. For example, the system may communicate the message “Use of this mobile phone device was detected while moving in a vehicle. The license plate of the vehicle has been photographed and the owner of the vehicle may be cited upon further review by law enforcement.” Also in further alternative embodiments, the message communicated to the mobile phone may include details regarding the fine and/or need for a court appearance. Further, the message may include a telephone number, address or web site which can be contacted for purposes of verifying that the car has been ticketed and/or for use with paying the fine associated with the violation.

In another example, mobile phones may include an application that is operative to periodically provide their geographic location to a remote server. Such a remote server may monitor such received data to determine mobile phones that are in a particular range of locations that should receive an alert message. If a detected device is in such a range of locations, the server may cause the mobile phone to receive an alert message (e.g., via the application itself, or via a SMS message or other communication that the mobile phone is capable of receiving). In a further embodiment, rather than the applications of each phone reporting their current locations to the remote server, the remote server may instead communicate to mobile phones the particular ranges of geographical locations in which alert should be emitted. The application on the mobile phone may then periodically compare its current location (e.g., determined via a GPS in the mobile phone) to the ranges of locations received from the remote server that are intended to issue an alert. If there is a match between the current location of the mobile phone and the range of locations received from the remote server, the mobile phone may then issue the associated alert message received from the remote server.

In an example embodiment, such an alert message issued by the application, may include a siren noise or other sound, flashing the display screen of the mobile phone, and/or causing a camera flash to turn on and off. Such an alert message may also include a message displayed on the mobile phone screen which describes the alert. In example embodiments, alert messages for example may include information that a shooting has occurred in particular place such as at a school, church, place of work, or other location. The range of locations that trigger an alert may be selected to be locations in the same location (e.g. the same building) and/or a wider area outside the location, so as to alert people traveling to the location.

In a further example embodiment, the server may be configured to be in communication with sound sensors that are operative to accurately detect the sound of a shot from a gun. Responsive to the detection of a gunshot by such sensors the server may be operative to determine a geographical range of locations associated with the location of the sound sensors, and cause mobile phones having the previously described application to receive an alert regarding the detected shooting. In an example embodiment, the server and the sensors themselves may be operative to carry out triangulation calculations regarding the sound levels of a detected gunshot detected by two or more sound sensors in order to more accurately determine a location of the gun shot. However, it should be appreciated that the server alternatively or additionally may be capable of receiving inputs from a user as to a range of locations to issue alert messages and the text that describes the alert which is to be communicated to mobile phones in the inputted range of locations.

The previously described image capture devices may include still or video cameras operative to capture images of visible light. However, it is to be understood that the image capture devices may also include cameras or other devices operative to capture non-visible light such as infrared radiation.

In an alternative embodiment, infrared cameras may capture images of the vehicle which show the location of warm objects inside the vehicle, such as people. If only one warm object is detected in the vehicle, the system may be operative to determine and/or indicate that the vehicle includes only one occupant that is both driving the vehicle and using a mobile phone. Such a determination can be made using an infrared camera in cases such as at night when it is too dark to capture images of the occupants of the vehicle with a visible light camera. Also, in cases where the driver is using a hands-free mobile phone, an infrared camera determination of only a single occupant in the vehicle can be used by the system to indicate likely illegal use of a mobile phone by the driver of the car.

In addition, as discussed below in more detail, infrared image capture devices may be used to capture the interior detail of a vehicle, which details may not be visible using visible light image capture devices. For example, in order to acquire interior images of a vehicle, the image acquisition system may be capable of overcoming windshield glare which tends to obscure or hide the driver of the vehicle. When light strikes a transparent surface, part of the light is transmitted through the surface, part of the light is reflected, and part is absorbed by the material. The amount of light reflected at the surface is highly dependent on the angle of incidence. Reflection of light may be specular (that is, minor-like) or diffuse (that is, not retaining the image, only the energy), depending on the nature of the interface. Glare can be defined as the contrast-lowering effect of stray light in a visual scene. Such stray light may come from direct or reflected sunlight or artificial light such as car headlamps and street lamps.

The windshield of a vehicle must transmit 70 percent of light in the visible spectrum according to the Federal Motor Vehicle Safety Standards Part 571.205. A dirty windshield can transmit much less light and/or reflects more light than a clean one, thereby creating more glare in an image of the outside of the windshield captured by a camera. Light reflecting off of the windshield can produce a specular reflection or a diffuse reflection, depending on the light source. On a sunny day, a specular reflection from the sun can happen if the sun is directly overhead. This results in a direct reflection of the sun on the windshield creating an intense glare. On a cloudy day, the sun's rays are dispersed through the clouds giving a diffuse reflection. This results in the windshield appearing white to the observer.

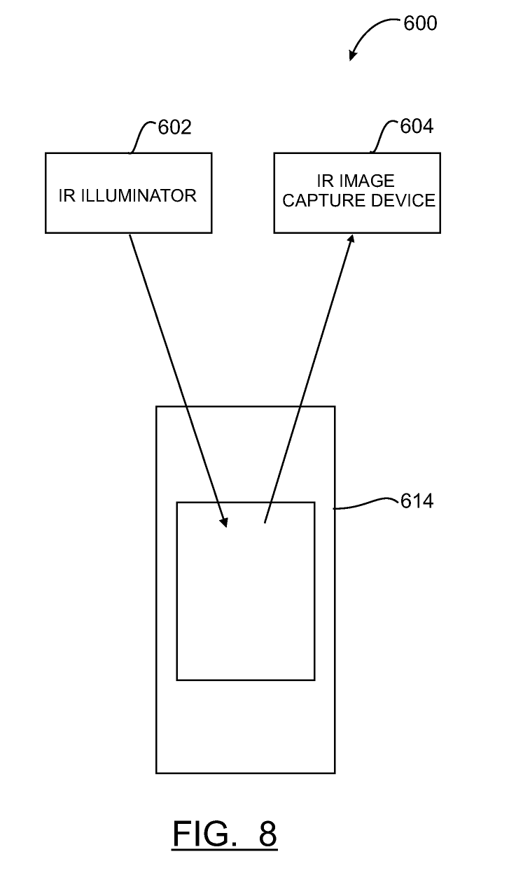

To remove and/or reduce the glare and/or remove shadows from the interior of the vehicle in images, one or more of the previously described embodiments of the image acquisition system 200 may use infrared light to illuminate a vehicle. An example of an image acquisition system 600 that uses infrared light to illuminate a vehicle 614 is shown in FIG. 8. Here the image acquisition system 600 may include an infrared illuminator 602 that emits infrared light in a wavelength that is invisible to the human eye, but is detectable by a CCD or other type of sensor of an image capture device 604. For example, an infrared illuminator may output infrared light at wavelengths above 760 nanometers.

Examples of devices capable of emitting infrared light include light emitting diodes (LEDs), halogen lamps and diode lasers. However, not all of these technologies may be capable of outputting infrared light with sufficient power to illuminate a vehicle at a distance. Thus, in exemplary embodiments, the particular infrared illuminator chosen should be capable of outputting a sufficient amount of infrared light to illuminate at least portions of vehicle from a position of at least 20 feet from the vehicle.

An example of a commercially available infrared illuminator that may be used in embodiments of the image acquisition system 600 includes an ALS-40 infrared illuminator of Electrophysics Corp. The ALS-40 infrared illuminator uses a 40 watt diode laser to produce coherent light at 810(±2) nanometers. This wavelength is invisible to the naked eye except for a faint red glow at the front of the illuminator. Infrared illuminators of this type are available with a beam angle of 10°-80° in increments of 5° both in the horizontal and vertical directions. An ALS-40 with a beam angle of 20° was used to capture the images show in FIGS. 11 and 13-15 described in more detail below.

Infrared illuminators used in example embodiments may have an optical system capable of spreading the initial diode laser beam out so that the power density is below the maximum permissible exposure according to the standards of the Center for Devices and Radiological Health of the United States Food and Drug administration (21 C.F.R. Sec. 1040) and the requirements of the International Electrotechnical Commission (IEC-60825-1). Under these standards the example ALS-40 infrared illuminator is classified as a Class 1 Laser Device which presents no danger of eye damage in the manner used in the examples described herein. Examples of optical systems which may be used in an example infrared illuminator 602 are shown in U.S. Pat. No. 6,442,713, which in hereby incorporated by reference herein in its entirety.

As shown in FIG. 8, the example image acquisition system 600 may include an image capture device 604 (e.g., digital still or video camera) having high resolution, low light sensitivity, and spectral response in the infrared region of the electromagnetic spectrum. Commercial examples of infrared cameras capable of being used for the described image capture device 604 may include a Sentec STC-400HOL camera and an ImagingSource DMK21AU04 camera. These cameras have different features and employ different CCD chips. The Sentec STC-400HOL is a monochrome camera utilizing a Sony ½″ interline CCD. The resolution is 570×485 TV lines. The camera shutter speed can be adjusted manually from 1/60 to 1/10,000 by setting the DIP switches on the camera board. The analog video signal is outputted through a BNC connection. The ImagingSource DMK21AU04 is a USB monochrome camera which uses a Sony ¼″ progressive scan CCD. It has a 640×480 pixel resolution and is capable of taking up to 60 images per second. This camera has automatic adjustments for shutter speed, gain and offset.

In example embodiments, the image capture device 604 must also include a lens with a focal length appropriate for the intended spacing between the image capture device and the portion of a street/highway for which images of vehicles will be captured. For example, a 12 mm lens may be used to give a 10′×10′ field of view at about 45 feet away. This field of view approximately corresponds to one street lane wide. However, it is to be understood that in other spatial arrangements, shutter speeds, image capture devices with lenses in other focal lengths may be used.

In example embodiments, the image capture device may employ a filter to block part of the incoming light from hitting the CCD sensor of the camera. For working within the infrared region of the electromagnetic spectrum, the visible part of the light spectrum may be blocked. The previously described Sentec STC-400HOL camera is equipped with a longpass filter which blocks light below 805 nm installed between the camera sensor and the lens. For cameras that do not include a built-in filter, such cameras may be fitted with a filter that corresponds to the wavelength range produced by the infrared illuminator 602. For example, for use with the ImagingSource DMK21AU04 camera, a narrow band pass filter (NBP-810-10-45) from Infrared Optical Products centered at 810 nm may be used. Such a filter has a center wavelength of 809.6 nm and a full width half maximum of 10.6 nm, which approximately matches the type of output from the ALS-40 illuminator.

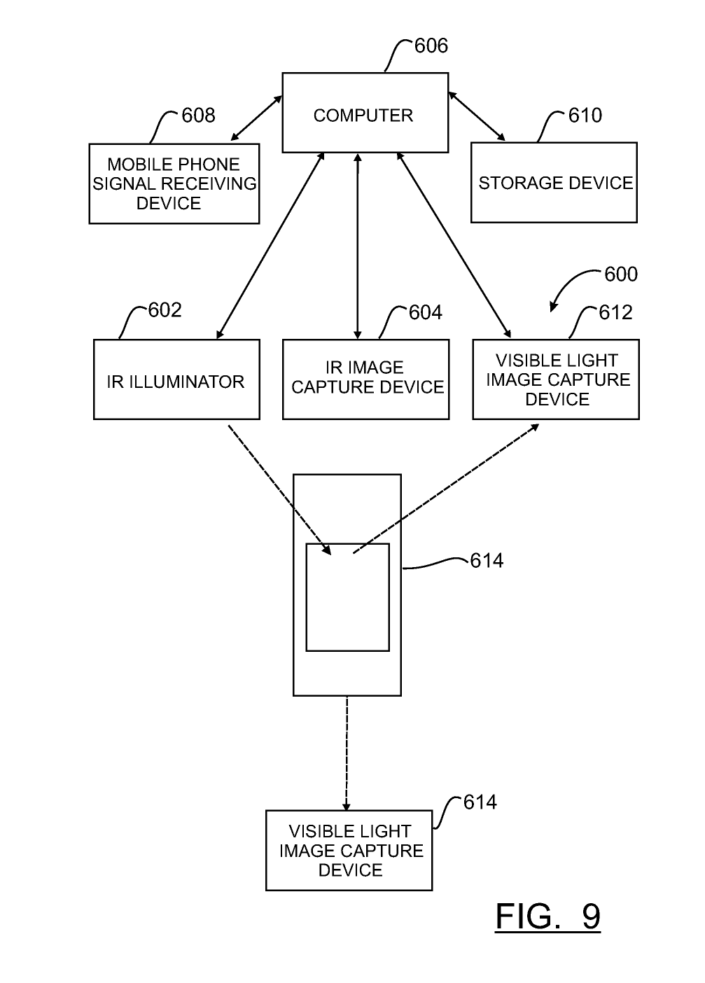

FIG. 9, shows an example of the previously described detection system which employs an image acquisition system 600 having an infrared illuminator 602. As discussed in previous embodiments, the image capture device 604 may be in operative connection with a computer 606 (which comprises at least one processor). Also as discussed previously, the at least one computer may be in operative connection with a mobile phone signal receiver device 608 and at least one local or remote storage device 610 (i.e., a data store). The at least one computer may be operative to control the image capture device to acquire images which are stored in the at least one storage device. The least one computer may also enable the images to be reviewed (e.g., accessed locally or communicated to a remote server) for purposes of determining whether a person associated with the vehicle should be prosecuted for illegal use of a mobile phone while driving the vehicle.

Also, as discussed with respect to previously described embodiments, the example image acquisition system 600 may include more than one image capture device of one or more different types. For example, the image acquisition system 600 may employ at least one image capture device 604 in the form of a camera adapted to capture infrared light illuminated onto/into a vehicle 614 via an infrared illumination device 602. Also, the image acquisition system may employ at least one visible light image capture device 612 adapted to capture visible light (e.g., light from the sun or other light source) reflected from the car and/or driver. In some embodiments, the infrared camera and the visible light camera may be positioned to capture images of the car at about the same time and from similar vantage points. Such a vantage point may be chosen so as to maximize the visibility in captured images of a driver holding a mobile phone inside a typical range of sizes and shapes of vehicles. Also, visible and/or infrared light image capture devices 614 may be positioned to capture images of the license plate of the vehicle and/or other views of the vehicle and/or driver. However, it is to be understood that alternative embodiments may include one or more visible and/or infrared image capture devices positions are similar and/or different vantage points. Also, it is to be understood that one or more image capture devices and/or one or more infrared illuminator may be triggered to capture/store images and/or output infrared light respectively, responsive to one or more triggering events. Such triggering events may include the detection of a mobile phone signal with the mobile phone signal receiver device, as discussed previously. Such triggering events could also be the detection of the presence of a vehicle via the vehicle presence detection device, as discussed previously.

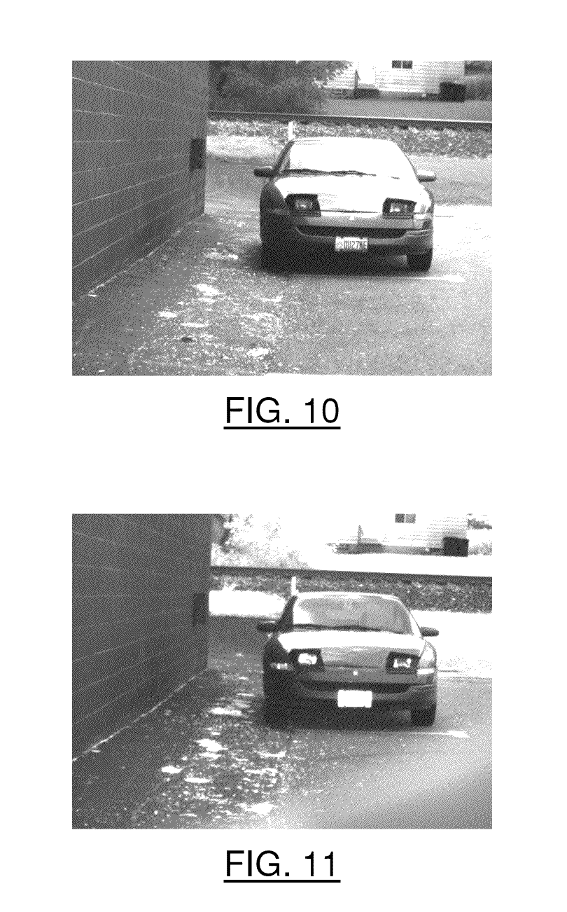

FIGS. 10-14 show examples of images captured using an embodiment of the image acquisition system 600. FIGS. 10 and 11 were taken on a cloudy day with an ImagingSource DMK21AU04 camera serving as the image capture device 604 and with the ALS-400 serving as the infrared illuminator 602. No infrared illumination was used to capture the image shown in FIG. 10. As a result, the image of the windshield appears white due to the diffuse sunlight. In FIG. 11, with the same diffuse sunlight as FIG. 10, the infrared illuminator was used to illuminate the vehicle during the capture of the image with the ImagingSource DMK21AU04 camera. In FIG. 11 the diffuse glare shown in FIG. 10 has been reduced, which enables the interior of the car to be visible.

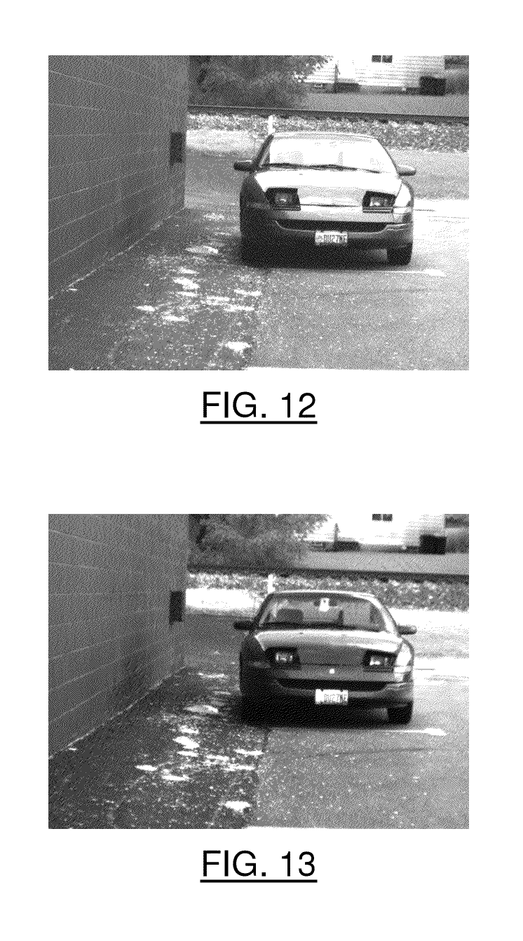

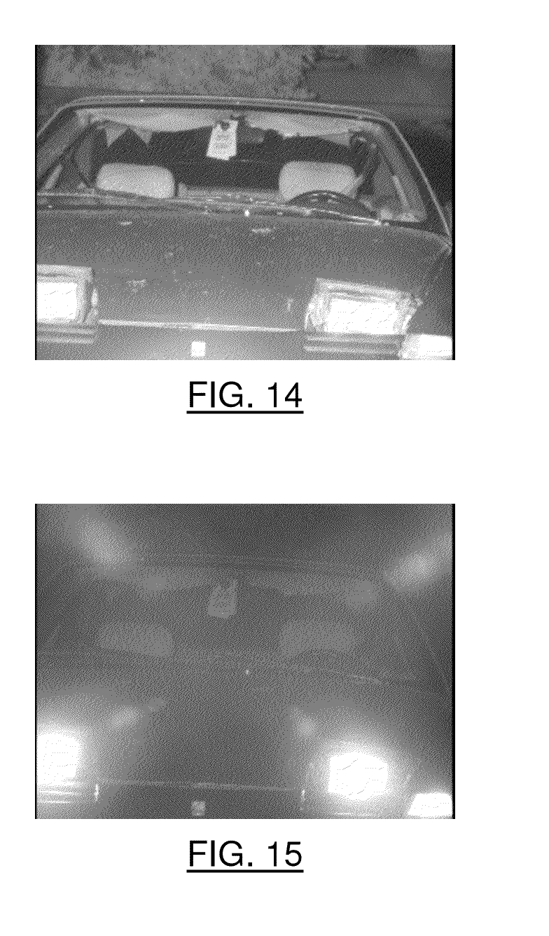

FIGS. 12 and 13 were taken during a break in the cloud cover with the ImagingSource DMK21AU04 camera. No infrared illumination was used to capture the image shown in FIG. 12. As a result, glare on the windshield significantly reduced the interior details of the vehicle captured by the camera. In FIG. 11 the infrared illuminator was used to illuminate the vehicle. In FIG. 11 the glare shown in FIG. 12 has been reduced, which enables more visible details in the interior of the car to be visible. FIGS. 14 and 15 were taken at night at a distance of 20 feet with the Sentec STC-400HOL camera with a zoom lens. Both images were taken with the infrared illuminator directed to illuminate the vehicle with infrared light. In FIG. 14 the headlights of the vehicle are off. The resulting image shows interior details of the vehicle. In FIG. 15 the headlights of the vehicle are on. Although the visibility inside the vehicle is reduced with the headlights on (compared to FIG. 14), many interior details inside the vehicle are still visible.

In addition to using visible and/or infrared image capture devices to determine information about the occupants and mobile phones in a vehicle, in alternative embodiments other types of sensors or radiation receiver devices may be used. For example, an ultrasonic detector may direct an ultrasonic signal into the vehicle. Features of the reflected ultrasonic signal may be used to determine characteristics of the inside of the vehicle.

In another example embodiment, a laser light beam may be directed onto vehicles from a laser positioned adjacent the roadway on which vehicles are moving. Reflected light from the laser light beam may be captured by a laser light sensor (and/or a camera) included in the system. Properties and/or patterns of the reflected light may be influenced by properties and/or patterns (e.g. wireless signals, sound vibrations, heat) associated with a mobile phone conversation and/or operation of a mobile phone in vehicle. Information captured from the reflected laser light beam may then be analyzed by a processor in the system to determine information useable to detect and/or corroborate illegal use of a mobile phone in a vehicle.

For example, sound waves from conversations in a vehicle (while the driver is talking on a mobile phone) may cause corresponding vibrations in the windows of the vehicle. In an example embodiment, the reflected laser light off of a window of the vehicle may include information corresponding to the vibration of the window, which is usable by the processor of the system to reproduce the conversation that occurred inside the vehicle. Details of the conversation may then be used to corroborate that the driver was talking on the mobile phone while driving.

In further embodiments, characteristics of the inside of the vehicle gathered from visible light cameras, infrared cameras, or other types of detectors such as ultrasonic detectors may be evaluated by an expert system, image analysis software, neural network, or other artificial intelligence system. As used herein, an artificial intelligence system corresponds to any device, software or system capable of determining useful information from data captured by the described detection system. Such an artificial intelligence system may be implemented as a software program in the previously described computer and/or may be implemented in a remote server operative to receive information from the described detection system. The artificial intelligence system may be operative to determine from the various types of images and other signals captured for the vehicle, whether the vehicle includes one or more occupants, and which one of the occupants is likely using a mobile phone. The artificial intelligence system may include image analysis software that is operative to determine the kind, type, and/or model of mobile phone being used. The artificial intelligence system may also include facial recognition software operative to identify features of faces in the vehicle. Such identified facial features may be used to determine identities of the occupants of the vehicle via use of a database of correlated facial features and person identities. For example, the artificial intelligence system may be operative to determine whether a particular person of interest (e.g., a wanted criminal) is present in the vehicle.

In addition, the artificial intelligence system may include software operative to determine the make and model of the vehicle, and/or other characteristics or measurements of the vehicle such as the size, the color and/or the type of vehicle (e.g., a truck, car, bus, or other type of vehicle). In addition, the artificial intelligence system may include software operative to determine information about the occupants of the vehicle, such as the number of occupants, their genders, sizes, hair color, hair styles, clothing, or any other information that can be used to distinguish one person from another person.

In example embodiments, an artificial intelligence system and/or image analysis software maybe operative to evaluate captured images of people in a vehicle (or other location) in order to automatically identify mobile phones being held and/or used by the users. Such a determination by the artificial intelligence system and/or image analysis software may be used by the one or more system described herein to verify and/or corroborate that the captured images of a vehicle (or other location) are of a vehicle (or other location) from which mobile phone usage is taking place.

In an example system, the data collected and determined by the system may be stored in a local and/or a remote data store, for not only the vehicle for which mobile phone signals are detected, but also other vehicles as well. The data collected may be aggregated for use with evaluating or determining patterns and other characteristics regarding the vehicle traffic on the roadway (or roadways) being monitored.

For example, in one embodiment, the system may be operative to track the detection of the same car (via license plate number or other detected data). The system may be operative to determine if the same vehicle has traveled on the same roadway multiple times at or above a predetermined threshold over within a predetermined time period. The detection of the vehicle multiple times may be indicative of a criminal evaluating a potential target. The detection system may be operative to report the license plate number and/or other determined data for the vehicle to law enforcement or other parties for further evaluation.

In further examples, such an artificial intelligence system may include software operative to determine if other violations of the law are being committed. For example, the artificial intelligence system may be operative to determine if a seat belt is being used by one or more occupants. Also for example, the artificial intelligence system may be operative to determine if a baby carrier or child seat is present in the vehicle, and if a baby or child is presently in the baby carrier or child seat. Further, the artificial intelligence system may be operative to determine whether the baby carrier or child seat is facing in the wrong direction and/or is illegally mounted in the front of the vehicle. Further, the artificial intelligence system may be operative to determine if a baby or small child is present in the vehicle but is not sitting in a baby carrier or child seat. In addition, some jurisdictions may prohibit an adult from smoking in a vehicle while a baby or child is also in the vehicle. Determination of possible illegal activities may be reported by the system to law enforcement or other persons capable of issuing citations to persons associated with the vehicle.

In embodiments of the described system, the image capture devices may be operative to capture multiple images of a vehicle as it moves along a road. For example, the image capture devices may be capable of capturing multiple images per second. Each image may show the vehicle in an offset position and/or with a change in size, depending on the direction of travel of the vehicle with respect to the location of the camera.

These images may be evaluated by at least one computer in the system to estimate the velocity of the vehicle. The at least one computer may include image evaluation software capable of detecting and quantifying changes in the size and/or location of the vehicle captured in a set of images. Using known information, such as the time each image was captured and the relative geometric positions between the cameras and the moving vehicle, the software may be configured to determine an estimate for the velocity of the vehicle.

For example, an image capture device may be positioned to capture images of the license plate of a moving vehicle. License plates typically have a rectangular shape with a width and height that can be readily measured by software analyzing the images. License plates also include numbers and/or letters with sizes that can be readily measured from the captured images. An example embodiment of the software may be operative to compare the measured widths of identifiable features (e.g., plates, letters, numbers, and/or the vehicle itself) in the images to determine a change in size of one or more features from one image to the next image in time. Velocity of the vehicle may be determined based on the change in size of the measured feature and the amount of time that has passed between the images.

Embodiments of the system may also include an initial setup procedure to configure the software to accurately measure velocity given the particular arrangement of the system. Such a setup procedure may include the input of the relative locations and/or optical features of the one or more image capture devices. Such a setup procedure may involve operating the system with one or more test vehicles moving at known velocities for purposes of calibrating/configuring the system to calculate velocity accurately from images.

In addition, features on the vehicle captured in the images, such as the lettering on license plates, may have known sizes. Such known sizes may be stored in or accessed by the software for use with calculating velocity of the vehicle captured in the images. Alternative embodiments of the image evaluation software may use the known sizes of different letters and numbers or other features of the vehicle to automatically determine velocity from the images without having the system undergo a manual calibration setup procedure with respect to measuring velocity.

In systems with multiple image capture devices (capturing different views of the vehicle), each of the different views of the moving vehicle may be used by the system to estimate the velocity of the vehicle. The determined velocity of the vehicle may correspond to an average of the velocity measurements for the different views. Also, discrepancies between velocities associated with different views, may be used by the system to gauge the accuracy of the measurements.

As discussed previously with respect to FIG. 2, embodiments may include the system carrying out a step of determining if a speeding violation has been committed responsive to the velocity of the vehicle estimated by the system and the speed limit for the section of the road being monitored by the system. This determination can be used by the system to trigger and/or enable the prosecution of the driver for exceeding the speed limit, whether or not illegal use of a mobile phone is detected for the same vehicle.

As discussed previously, example embodiments of the described system may include components (such as image capture devices) mounted adjacent to (or in visual range with respect to) a roadway through which vehicles travel. However, it is to be understood that alternative embodiments may be mounted in other predetermined locations at which it may be desirable determine whether mobile phone communications are taking place. Such other locations may include border crossings, casinos, buildings, prisons, hospitals, airplanes, trucks, cars, construction equipment, and other types of buildings, vehicles, and geographical locations. An example of an alternative embodiment of a detection system operative to detect mobile phone signal originating from a predetermined location (e.g. a vehicle and a prison) and operative to communicate the detection (and the predetermined location of the detection) to a monitoring system, is found in U.S. application Ser. No. 12/433,219 filed Apr. 30, 2009, which is hereby incorporated herein in its entirety.

In some of these alternative embodiments, image capture devices may not be used (or needed) to determine that a mobile phone signal is originating from a predetermined location. For example, in an alternative embodiment, mounted inside a vehicle, or a room in a building (e.g., prison cell), a mobile phone signal receiver device may be configured with one or more antennas operative to provide sufficient information for a computer system in the vehicle or building to verify that a particular detected mobile phone signal is originating from inside the vehicle or room in the building (and not outside the vehicle or room). In this example, the predetermined location corresponds to the interior of the vehicle or the room of the vehicle. Upon determination that the mobile phone signal is originating from the predetermined location, the detection system is operatively configured to notify a remote server that a mobile phone signal was generated in the predetermined location.

In the case of a vehicle (or other predetermined location), the detection system may include a wireless network interface device that connects to a wireless network in order to communicate with the remote server. The remote server may then be operative to notify (via SMS messages, database logs, e-mail, web interface, or other electronic communication) a further person or entity of the detection of the mobile phone signal and usage in the particular predetermined location.

This described alternative example system may be used by employers, parents, or other parties, to receive electronic notice when a person is using a mobile phone (in violation of a company or parent rule against such use) in a particular vehicle. As described in more detail in U.S. application Ser. No. 12/433,219, the system mounted in the vehicle, may be operative to detect when the vehicle is moving and the velocity at which the vehicle is moving. Such information regarding velocity in U.S. application Ser. No. 12/433,219 was described as being used to determine when to emit an interruption RF signal (also referred to as a blocking signal) with an interruption signal transmitter device in order to disrupt the mobile phone signal in different ways depending on predetermined velocity ranges. However, in the described alternative example system, in place of (or in addition to) emitting an interruption RF signal, the system may be configured to notify the remote server of mobile phone usage in the vehicle based on the particular speed of the vehicle. For example, the detection system may include one or more configurable velocity thresholds stored in a memory of the system. When the vehicle is determined by the system to not be moving, the system may be configured to not notify the remote system of mobile phone usage in the vehicle. However, when the velocity of the vehicle is detected by the system to be greater than zero, or some other configurable velocity, the system may be configured to notify the remote server of mobile phone usage while the vehicle is moving at and/or is above such some configurable velocity threshold.

In this described embodiment, the system may include a wireless network interface device capable of communicating with the remote server through a cell phone based network. In a further alternative embodiment, the detection system may include an 802.11(a, b, g, n, 2012, ac, and/or ad) compatible wireless network interface device configured to communicate with a wireless access point rather than a device which communicates with cell towers. In addition, in another embodiment, the detection system may include a Bluetooth (or other short range communication signal) based network interface device that is operative to be configured to communicate with the remote server through the wireless network capabilities of the mobile phone being detected (e.g. via tethering).

In these embodiments, the detection system may store in a local data store, event data regarding the detection of one or more communication uses of the mobile phone in the vehicle. Such event data may include all or portions of each communication, the date, time, and duration of each communication, the velocity of the vehicle and/or the location of the vehicle during the detected communication (determined through a GPS device included in the system) and any other data associated with the detection of the mobile phone signal and/or the operation of the vehicle during the detection. The system may continually or periodically transmit at least portions of such collected data regarding mobile phone use events to the remote server. Also for systems that do not include a continuous wireless connection with the remote server (e.g., systems using an 802.11 a, b, g, n, 2012, ac, and/or ad type wireless network interface device), when the vehicle passes near a compatible wireless network in a home garage, parking lot, or other location, the system may be operative to automatically detect the network and begin communicating detected events held in the data store to the remote server. In addition, the system may be operative to wait until a request is received from the remote server through the detected wireless network prior to sending the data stored in the local data store to the remote server.

In this described embodiment of a detection system mounted in a vehicle, the system may be operative to record in the data store, all or at least a portion of the wireless communications (voice and/or data) transmitted from the detected mobile phone (which as discussed previously may include any type of communication device operative to communicate wirelessly from the vehicle). In addition, an alternative embodiment may be operative to automatically detect which wireless signals are being received by the mobile phone in the vehicle and to record all or at least a portion of these received communications as well in the data store.

The storage (and/or the reporting to the remote server) of such data regarding the detected communications may occur for all detected communications or may be triggered based on the detected velocity of the vehicle surpassing a configurable threshold stored in the system. However, alternative embodiments may also be operative to trigger the storage (and/or the reporting) of such data regarding a detected communication on other events such as the time of day, a schedule, the frequency band of the communication, the type of communication (e.g. voice or data), or any other information regarding the use of the mobile phone, the operation of the vehicle, or any other data accessible to the detection system inside the vehicle.

As discussed previously, embodiments of the detection system may correspond to a device mounted in the vehicle that is operative to directly detect mobile phone signals originating from mobile phones inside the vehicle (via an antenna which receives the mobile phone signal). However, an alternative embodiment may be operative to detect mobile phone usage by monitoring Bluetooth signals (or other short range wireless signals) between a mobile phone in the vehicle and a hands free device. Thus, as used herein the detection of a mobile phone signal (such as those between the mobile phone and a cell tower) may also include the detection of such signals indirectly through detection of other signals transmitted to and/or received from the mobile phone (e.g. Bluetooth).

Also, the detection system may be operative to determine a mobile phone number or other indentifying information from the mobile phone signals detected by the system. Detected identifying information may be stored in a data store of the system. The system may be operative to compare indentifying data currently being detected to corresponding indentifying data previously stored in the data store of the system to further corroborate that the detected mobile phone signals originated from a mobile phone likely being used by the driver of the vehicle (rather than from a random mobile phone of another person outside the vehicle.)

In addition, in embodiments in which the detection system is mounted in a vehicle, room, or other location, the system may include, or be in operative connection with radiation receivers (also mounted in the vehicle, room, or other location) which detect radiation other than mobile phone signals. For example the system may include a camera that is operative to capture images of the driver and/or a microphone that is operative to capture an audio recording of the driver talking. Such images and audio recordings could be evaluated (by the detection system itself, another remote system, and/or a human) to determine if the person depicted in the images or talking in the audio recordings, was using a mobile phone. In further embodiments, the radiation receiver mounted in the vehicle or other location in operative connection with the described system may detect other types of radiation, including other types of electrometric radiation and/or particles emitted in the vehicle or other location.

In example embodiments that include an interruption transmitter device, the system may include a direction antenna capable of emitting an interruption RF signal at a higher power in one direction relative to an opposite direction. For example, as shown in U.S. application Ser. No. 12/433,219, the antenna that emits the interruption RF signal may be mounted under the seat of the driver of a vehicle and may be operative to emit an interruption RF signal at a higher power generally upwardly, relative to the power of the interruption RF signal emitted in other directions from the antenna. For example, the antenna may be adapted to transmit the interrupting RF signals upwardly in directions in which substantially all of the power of the emitted RF signals is directed substantially within 80 degrees of a vertical axis. Also it should be appreciated that the detection system and/or antenna may be mounted in other locations (other than the under the driver's seat of a vehicle) targeted at the likely source of the mobile phone signal.

In example embodiments, such an antenna may also be used to detect mobile phone signals. However, in other embodiments, different antennas may be used to receive and transmit RF signals. As an example, the antenna may have a size operative to fit under the seat of a vehicle (e.g. a size not greater than 6 inches×6 inches×15 inches. The antenna may be operative to receive and/or transmit RF signals in a frequency range of 700 MHz-2200 MHz and/or other cellular phone bands or signals that can communicated by mobile devices. The half-power beam width of the antenna may be less than 10 degree (both directions) for example. The gain of the antenna may be greater than 5 dB for example. The impedance of the antenna may be 50 Ohm for example. The SWR of the antenna may be less than 1.6 across the band for example. The forward to back lobe ratio may be greater than 20 dB for example. The antenna may also include a single SMA female connector or other type of connect for connecting the antenna to the described system. However, it should be appreciated that in other embodiments, other types of antennas may be used to receive and/or transmit RF signals.

In addition, in a further alternative embodiment of the detection system, the detection system may correspond to software and/or firmware that is installed on a mobile phone being monitored. In this embodiment, the processor (which carries out the described functions of the detection system) is the processor of the mobile phone. Also in this embodiment, the mobile phone signal receiver device, may include software that is operative to detect when the mobile phone is being used (e.g. to make calls, text message etc.) through the internal software, data, and/or hardware of the mobile phone.

In this described embodiment, the detection system may communicate with the remote server through the communicating features of the mobile phone. For example, if the mobile phone includes Internet access, the described detection system may use the Internet access of the mobile phone to communicate with the remote server through the Internet. However, if the mobile phone only includes voice communications (e.g. no Internet access), the described detection system may be operative to call a phone number associated with the remote server in order to communicate data via a modem connection.

In addition, in this described embodiment, the detection system may use the GPS capabilities of the mobile phone to determine the location and/or velocity of the vehicle. In this embodiment, the detection system is operative to determine that the detected mobile phone signals (detected via software/hardware) are being transmitted from a predetermined location corresponding to the inside of a vehicle, based on the detected velocity surpassing a predetermined threshold. For example, when the determined velocity is relatively low and is compatible with a person walking (e.g., 2-4 miles/hour), the detection system may be operative to not report the detection of transmission of the mobile phone signals to the remote server. However, when the velocity is above a threshold typically associated with a moving vehicle (e.g., above 15 miles/hour), the detection system may be operative to store and/or report data regarding the mobile phone use to the remote server.

In this described embodiment of the detection system operating in the mobile phone, the detection system may correspond to a detection application that is downloaded and installed on the phone. Such a detection application may have security features which prevent a user (without a proper password or other credential) from temporarily deactivating the application in order to make undetected mobile phone calls while driving the vehicle. Alternatively, if the user using the phone retains the ability to deactivate this described detection application, the detection application may include a log of when the detection application was running and may be operative to compare this to a log of when the mobile phone was powered on, in order to detect and report to the remote server that the detection application was deactivate for a period of time while the phone was still powered on.

In a further example, a mobile phone may be adapted to include a communication blocking application which automatically disables the ability of the mobile phone to receive and/or send phone calls and/or text messages responsive to the mobile phone detecting that it is moving at a velocity that is above a minimum predetermined threshold. Such a minimum predetermined threshold may correspond to 2-4 miles/hour or other velocity that is higher than a typical human walking velocity. Such a communication blocking application may be configured to allow 911 calls (or other emergency numbers) regardless of the velocity that the phone is moving. Also such a communication blocking application may be configured to allow communications when the velocity is above a configurable maximum predetermined threshold. Such a configurable maximum predetermined threshold of speed may be set to correspond to a velocity equal to or greater than a configured level that is higher than the speed of a typical car and/or is likely indicative of the user riding in an air plane or fast train rather than driving a car. This described communication blocking application may be operative to detect velocity using velocity detecting features of the phone such as a GPS, and/or via an analysis of the RF signals from one or more cell towers.

In an example embodiment, the described communication blocking application may be an application that is integrated into the operating system of the mobile phone and/or is an application that is pre-installed on the mobile phone via the carrier or other entity that sells, manufactures, and/or provides the phone to the user. Such a communication blocking application may be configured to continually operate in the phone while the phone is powered on. Such an application may also lack a user selectable setting in order to attempt to prevent a user from disabling the communication blocking application.

In another example embodiment, one or more applications executable on the mobile phone may be adapted to individually determine whether the mobile phone is likely in a moving vehicle. In response to this determination, such applications may be operative to individually disable one or more features (of their respective applications). For example social media applications (e.g., Facebook, Twitter), games (Angry Birds, Words with Friends), productivity applications (Gmail, Calendar), and entertainment applications (YouTube, Netflix) executing in a smart phone (e.g., an Android based phone, an iPhone, a Blackberry, or a Windows phone) may individually query the operating system of the mobile phone for data indicative of whether the mobile phone is moving at a sufficient velocity to be likely in a moving vehicle (as opposed to being held by a person walking). In response to such data, the individual application may disable one or features of the application that can distract the driver's attention from safely operating the vehicle. Also in response to such data, the application may display a message on the display device of the mobile phone, which provides information regarding the disabling of the application and/or feature. For example, a social media application directed to interfacing with a web service (such as Facebook) may disable the ability of the application to display content (e.g. posting's from friends) on the display screen of the phone, which content likely encourages a driver to look at the application on the mobile phone rather than the road, when driving a vehicle. The Facebook application may then display a message such as (“Slow down to see content”).

In another example, the application may prompt the user of the mobile phone to confirm that they are not driving a vehicle while using the mobile phone. For example, prior to enabling one or more features to be usable by the user, the application may cause a display device of the mobile phone to output a message such as “This device has been detected to be moving at a high rate of speed. Use of this application while driving a vehicle is prohibited. If you are not driving and wish to proceed using this application, you may select the following button”. The application may also provide a selectable button or other type of input control, for which the user can press, click or otherwise select in order to confirm that they are not driving (such as if they are a passenger in a car, bus, train, boat, or other vehicle). Such a button for example may display the text “I confirm that I am not driving a vehicle while using this application”. If the user provides an appropriate input (such as by pressing this confirmation button) the application may then proceed to allow them to access a remote server and/or carry out other actions with the application. If the user does not provide the inputs necessary to confirm that they are not driving, the application may continue to prevent to the user from accessing one or more features of the application.

Also, it should be appreciated that the application may check the velocity of the mobile phone one or more times during use of the application (e.g., such as on a periodic basis). If the application detects that the mobile phone may be moving in a vehicle, the application may again provide the above messages and require the user to input a confirmation input that they are not driving while using the application.

In an example embodiment, the application may store in a data store of the mobile phone (e.g., in a log file) data indicative of each occurrence that the user provided the confirmation input. Such stored data may include the date and time that the confirmation input was received, as well as other related data such as the detected velocity of the mobile phone. For applications that access content from a remote server (e.g., a social media application such as a Facebook application), the application may also communicate at least some of this stored data to the remote server.

In example embodiments, data indicative of velocity (for which the applications individually query the operating system of the mobile phone) may include GPS data acquired from a GPS in the mobile phone. However, it should be appreciated that embodiments of the operating system of the mobile phone may itself be operative to determine whether the mobile phone is likely in a moving vehicle. Thus in response to a query from an application regarding whether the mobile phone is likely in a moving vehicle, the operating system may simply return binary data such as True or False. For example, the respective applications may disable one or more features responsive to a True response from the operating system of the mobile phone regarding the phone likely being in a moving vehicle. Also the respective applications may enable one or more features responsive to a False response from the operating system of the mobile phone regarding the phone likely being in a moving vehicle.

In example embodiments, the operating system of the mobile phone (and/or the applications executing in the operating system) may be operative to acquire information indicative of velocity from the GPS in the mobile phone, from vibrations sensed with one or more accelerometers in the mobile phone, and/or from any other device, circuit, or application in the mobile phone, which provides information indicative of the velocity of the mobile phone. Also in example embodiments, the operating system of a mobile phone (and/or the applications executing in the operating system) may be operative to acquire information indicative of velocity of the mobile phone from communications with cell towers. Also in example embodiments, the operating system of a mobile phone (and/or the applications executing in the operating system) may be operative to acquire information indicative of velocity of the mobile phone from data provided by the vehicle (or other devices mounted in the vehicle) (e.g. via Bluetooth or other wireless communications).

In a further example, a disabler application which operates in the processor of the mobile phone, may be provided which disables the ability of the communication blocking application from blocking communications and/or disables the ability of the operating system and/or applications executing in the mobile phone from detecting that the mobile phone is moving in a vehicle. Such a disabler application may also (or alternatively) be operative to disable the ability of the previously described detection application from operating to detect when the mobile phone is being used to communicate while moving above a predetermined threshold velocity. In an example embodiment, such a disabler application may be a downloadable application that is capable of being installed on the mobile phone.

In an example embodiment, the disabler application may be operative detect the presence of the communication blocking application (and/or detection application) and cause execution of the communication blocking application (and/or detection application) in the processor of the mobile phone to be to terminated or paused. In a further embodiment, the disabler application may be operative to disable (i.e., turn off) use of a GPS device or other circuitry in the mobile phone that is used by the mobile phone to detect velocity by the communication blocking application, operating system, detection application, or other applications. In another embodiment, the disabler application may be operative to change and/or replace the velocity data provided by a GPS device or other circuitry in the mobile phone. For example, the disabler application may intercept and replace data from a GPS device indicative of a velocity (e.g., 35 miles/hour) which is above the minimum predetermined threshold to correspond to a velocity (e.g., 0-1 miles/hour) which is below the minimum predetermined threshold in order to prevent the communication blocking application from blocking phone calls and text messages.

In further examples, the mobile phone itself may be adapted via software/firmware to override the disabling of the usage of the mobile phone, when the mobile phone detects a predetermined signal that indicates that mobile phone usage is permitted. Such a signal could be transmitted form an external transmitter and may include authentication information such that the mobile phone can verify that the transmitted signal is from a trusted source (before the mobile phone permits usage of the mobile phone to make/receive a call, send/read text messages, and/or perform other actions). Such a transmitter may be mounted in a bus, train, (or other location) to enable the mobile phone use to be usable (even though the mobile phone may be moving above a predetermined threshold that can cause the mobile phone to be disabled).

As discussed previously, some embodiments described herein may include the use of an infrared illuminator that is positioned to transmit infrared light through a window of a vehicle so as to reflect off of a driver of the vehicle and be captured by an image capture device. Such systems may be located adjacent roads and highways in jurisdictions that prohibit drivers from holding a mobile phone to carry out mobile phone communications while driving. In another embodiment, an infrared illuminator detection device may be produced that includes one or more photo sensors adapted to detect the presence of the specific wavelength (e.g., 800 nm to 820 nm) of light transmitted from such infrared illuminators. Such an infrared illuminator detection device may include an output device such as an audible and/or visible output device that emits a sound and/or light when infrared light is detected from an infrared illuminator. In this described embodiment, the infrared detection device may be a portable device capable of being mounted adjacent to or on a dashboard or other area of a vehicle adjacent the inside windshield of the vehicle.

This described infrared illuminator detection device may also be incorporated into a radar/laser detector for use with detecting radar/laser speed detectors. This described infrared illuminator detection device may also be incorporated into and/or include an interruption transmission device capable of emitting an infrared light inside the vehicle which produces reflected infrared light that obscures the details of the inside of the vehicle that may be captured by an infrared image capture device associated with the detected infrared illuminator. The emitting of infrared light by the interruption transmission device may be triggered by the detection of an infrared illuminator using the described infrared illuminator detection device.

In previous example of systems that are operative to detect vehicles in a roadway using mobile phones (and which systems cause tickets to be issued for illegal use of a mobile phone while driving), such systems may be mounted adjacent the roadway being monitored. For example such systems may be mounted on one or more poles, buildings, towers, or other stationary structures. However, in a further embodiment such systems may be mounted on a moving vehicle such as a bus, truck, police vehicle, or other type of vehicle. As the vehicle (that includes the detection system) drives along roadways, the system may continuously monitor adjacent vehicles for use of mobile phones.

In this described embodiment, one or more cameras may be mounted to the vehicle (e.g., a bus, truck, police vehicle) to capture images of driver's of adjacent vehicles and images of the license plates of the adjacent vehicles. In addition, the vehicle (that includes the detection system) may include the previously described infrared illuminator in a position which is operative to illuminate adjacent vehicles. Further the vehicle (that includes the detection system) may include one or more mobile phone signal receiver devices and/or antennas which are operative to detect mobile phone signals being outputted from the adjacent vehicles. As in previous embodiments, at least one processor in the system (which is connected to the one or more cameras and one or more mobile phone signal receiver devices) may be operative to determine that the detected mobile phone signal originated from at least one position in the adjacent roadway in which an adjacent vehicle was present.

In this described embodiment, the system may also include a GPS, and may be operative to determine a location of the vehicle (that includes the detection system) when images of adjacent vehicles and/or mobile phone signals are detected. Such location information may be stored along with captured images, and mobile phone signal detection events and signals by the at least one processor in a local and/or remote data store. As in previously described embodiments, the information captured and stored in the data store may be used to issue and mail tickets to users associated with the license plates of the adjacent vehicles captured in the images by the camera(s) of the described system.

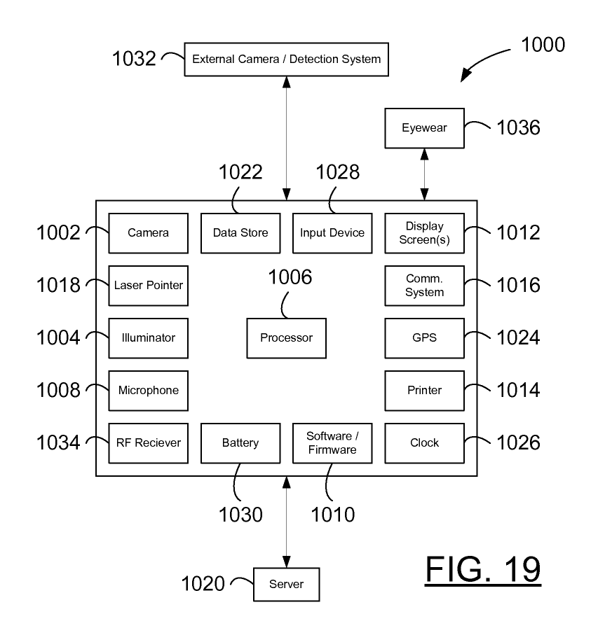

It should also be noted that one or more of the described embodiments herein may be packaged in a portable system (which may be hand-held). FIG. 19 illustrates a schematic view of such a portable system 1000. In this example the system may include a still/video camera 1002 and/or other sensors (e.g., mobile phone signal receiver device) and other features such as an illuminator 1004 (outputting IR and/or visible light and/or other types of radiation), which can be pointed towards a vehicle (e.g. by a police officer) in order to capture images and other data from a vehicle (or other location) which establish evidence of use of a mobile phone in the vehicle (or other location). Live and/or recorded video (and other images or data) captured and/or determined by the system may be displayed by the system on a display screen 1012. It should be noted that the portable system may include one or more display screens.

For a portable system 1000 with an IR-illuminator 1004, a sensor (e.g. the camera 1002 or other light sensor) may be used to capture the amount of ambient light adjacent the vehicle (or other location), which information may be used by a processor 1006 in the portable system to determine when to activate the IR-illuminator 1004 and the amount of light to output from the IR-illuminator.

As in previously described embodiments, the camera 1002 may be used to capture additional information such as an image of a license plate, and/or other physical features of the vehicle itself and/or occupants in the vehicle. This described portable system may include other sensors as well, such as a microphone 1008 capable of capturing audio of the operator of the portable system as well as audio of people and other sounds associated with video captured by the portable system.

As described in previous embodiments, such a portable system may also have software components (that execute in the processor 1006), which are capable of making determinations regarding the evidence collected by the system. For example the software operating in the system may include artificial intelligence software and/or image processing software capable of determining/verifying that a driver or other person depicted in the captured images is holding and/or using a mobile phone. Such software may provide a ranking for a plurality of different captured images as to the relative confidence level of the image showing evidence of use of a mobile phone (e.g., a ranking as to how clearly a mobile phone is shown being used by a driver of a vehicle) or other potential violation (e.g., a child not in a child/booster seat). Such a ranking may be displayed on the display screen of the portable system so that the operator can verify that the images captured are sufficient to serve as evidence in court (if needed) to prove the usage of the mobile phone (and/or other violations of the law).

In an example embodiment, the software associated with the portable system may be operative to carry out imaging processing of the video captured of an occupant of a vehicle or other persons in order to detect characteristics that have a high probability of indicating usage of a mobile phone. Such characteristics capable of being identified by the software from the captured images may include the location and orientation of a person's arm, hand, and/or a mobile phone adjacent a person's head. Such characteristics capable of being identified by the software may also include the detection of light from a display screen of a mobile phone near a person's head or near the steering wheel of the vehicle, or other location typically associated with a person talking, texting, or carrying out other actions with a mobile phone while driving. In addition such characteristics may include aspects of the person's eyes and/or head orientation which are indicative of a person looking at a mobile phone rather than looking at the road, mirrors, or instrument panel of the vehicle.

In addition, it should be appreciated that the display screen (or other components) of the mobile phone may have characteristics that make the mobile phone capable of being detected by the detection system. Software associated with the portable system or a server in communication therewith (or other examples of detection systems described herein) may be operative to evaluate images (still and/or video) depicting drivers of vehicles in order to determine whether an object depicted in the images has such detectable characteristics that are representative of a mobile phone. Such characteristics may include the shape of the display (e.g. rectangular, square); the orientation of the display (e.g. vertically or horizontally oriented); light patterns emitted from the display (e.g., patterns that form common user interfaces for a dial pad, sending/receiving text messages, viewing notifications); specific colors or color ranges associated with mobile phone displays; IR light or other non-visible light emitted from the display; lighted buttons (e.g., back or menu buttons); and/or any other visual characteristic capable of being captured via a camera of the portable system or other detections systems described herein.

In addition, it should be appreciated that mobile phones maybe adapted via software and/or hardware to cause the mobile phones to emit signals that enable the mobile phones to be more easily detected in images captured via cameras. For example, a mobile phone may include a software application that causes the mobile phone to strobe portions of the display, lighted buttons, camera flash, or other light emitting component of the mobile phone in one or more patterns that can be detected in video images captured via a camera. Such software in the mobile phone may be operative to trigger the strobing of one or more light emitting components (or portions thereof) of the mobile phone, responsive to uses of the mobile phone detected by the software. For example, anytime the display is non-blank, the software may be operative to cause one or more portions of the display or other light emitting components to begin emitting light in a detectable pattern. Alternatively, the software may be operative to cause light to be emitted in a detectable pattern from a light emitting component upon the detection of specific usages of the mobile phone. Such detected usages may include a user talking on the mobile phone, sending/viewing text or e-email messages, playing games, and/or any other activity that may distract a driver's attention. Also, in a further embodiment, the software may be operative to forgo emitting detectable light patterns for certain predetermined applications that are considered acceptable to use in a vehicle while driving (e.g. map, navigation applications). In addition, it should be appreciated that the described emitting of light patterns may be carried out using light that may include some non-visible frequencies (e.g. IR) capable of being outputted by the light emitting element of the mobile phone.

In example embodiments of the portable system or other detection systems described herein, a server, or other component of the described embodiments may be responsive to the imaging processing systems detecting a mobile phone via such characteristics captured in images via one or more cameras, to cause a ticket to be sent to the owner of the vehicle in which the mobile phone was detected, or carry out other actions, such as reporting the use of the mobile phone to an employer, parent, prison security, and/or a server that logs/reports such activity.

As described in previously embodiments, the portable system or other detection system may include image processing software capable of carrying out other determinations from images captured via a camera, such as: character recognition of numbers and letters in a license plate; the color, make, and model of a vehicle; facial recognition of the occupants of the vehicle; and/or any other information capable of being evaluated in the captured images.

Also, it should also be appreciated that in example embodiments one or more features or capabilities of the described artificial intelligence system and/or image processing software may be carried out on a remote server that receives the captured images (or other information) from the portable system or other detection systems described herein. Such a server for example may evaluate information captured by the portable system and report back to the portable system (or other detection system) information usable by an operator to assist in taking one or more actions (e.g., ticketing and/or arresting the driver of the vehicle)

In some embodiments such a portable system may include a built in printer 1014 operative to print tickets/citations. Also, the portable system may include a communication system 1016 capable of communicating the captured and/or determined information and other data (including manually entered date) to a remote server 1020. The portable system may also be operative to retrieve information about the driver/vehicle (e.g. registration information) from the remote server (determined from the server from the captured images and/or other uploaded data). Such a communication system may include communicating over a cell phone network and/or a local WiFi network.

As discussed in other embodiments herein, this described portable system may also include a GPS 1024 that is operative to provide location data which can be stored in correlation with captured video, and other data captured and/or determined by the system. Further, the system may include a clock 1026 capable of providing time and date data which can be stored in correlation with the data captured and/or determined by the system. In addition, the system may include one or more input devices 1028 such as a touch screen, buttons, keypad, or other input device, to enable the operator to provide additional data regarding an event, and/or to provide inputs usable to operate and/or configure the system.

In further example embodiments, the system may include a sensor (which may include the camera 1002 or other sensor) that is operative to capture temperature or heat information that may be unique to operating mobile phones. For example, mobile phones typically produce mobile phone signals in predetermined frequency bands. Such bands may be associated with characteristics quantifiable in terms of temperature or other properties that serve as a signature for mobile phone use. The described portable system (or another one of the described system herein) may be operative to capture the temperature or other detectable signature of mobile phone use, so as to further corroborate that the vehicle captured in one or more images corresponds to a vehicle that is actively using a mobile phone.

In this embodiment, the mobile phone may include a laser 1018, which may be pointed by an operator of the system at the location in a vehicle (e.g. near the driver of a vehicle) from which mobile phone signals may be transmitted. To accurately point the laser, reflected light from the laser may be captured by a camera of the system (along with video of the vehicle) and may be displayed on a display screen 1012 of the system. The sensor in the portable system that is operative to capture temperature (or other properties) may be configured to capture temperature (or other properties) from and/or adjacent to the location at which the laser light is pointed.

It should also be noted that data captured by such an example portable detection system (and/or other embodiments described here) may be stored on a removable memory card or other data store 1022, in addition to or instead of being communicated through a network to a remote server by the system.

Also, it should be noted that some embodiments of this described portable detection system may further include an RF receive device 1034, such as described previously, which is operative to detect mobile phone signals. Information from such signals may be stored by the system in the data store 1022 and/or in the server 1020 in correlated relation with the captured images and other information determined by the system.

In further embodiments, rather than only using a display built into a handheld portion of the detection system 1000, the system may use a display screen integrated into eyewear 1036 which is a wearable component adjacent the eyes of the operator such as in a visor, glasses, goggles, helmet, contact lenses, or other packaging which is not held by the operator's hands. Such eyewear may include sensors operative to detect the location of the operators gaze (e.g. via monitoring the position of the pupils of the operator's eyes) in order to control the operation of the eyewear and/or the portable system.

This described system may operate using electrical power stored in a battery 1030. Such a battery may be integrated into the portable system. However, such a battery (or an additional battery) may be mounted external to the portable system. For example, the battery (which may include several battery components) may be located in a belt or jacket worn by the operator of the system.

In further embodiments, the described portable system may be operative to acquire data from external sensors through the communication system 1016. For example the system may be operative to wirelessly acquire video from one or more external cameras 1032 (which may be included in an external detection system) mounted to a vehicle associated with the operator (e.g. a police vehicle) and/or external cameras mounted to stationary objects (e.g. a telephone pole, building, or other object). In an example embodiment, the portable system may be operative to wirelessly communicate messages to such external cameras based on the direction the portable system is pointed (and/or the detected gaze of the operator using the described eyewear) in order to cause the external cameras to move, focus, and/or zoom in on the particular vehicle and/or location in/on a vehicle (e.g., the driver's seat, license plate). In this manner the portable system can control the external cameras in order to acquire additional and/or different information useful for further corroborating usage of a mobile phone by the driver, and/or identify information (license plate number, make and model of vehicle, number of passengers or other data).

For example, the processor of the system may be operative responsive to the gaze of the operator's eyes (relative to the display screen mounted adjacent the operator's eyes) to carry out more detailed imaging processor of those portions of the displayed video for which the operator is gazing at. For example, the system may be operative to focus imaging processing (for purposes of detecting use of a mobile phone) on the area (areas) of the video the operator is gazing. In another example, the camera may include zooming, focusing, and/or articulating features which can be caused by the processor to align and/or zoom in on features of the live video that are being gazed at by the operator. As a result, the operator via looking at the location of a driver of the vehicle can cause the camera to operate (to move, focus, and/or zoom in) to capture more detailed images of the driver.

In addition, it should be appreciated that the external cameras 1032 may be operated by further detection systems in an automated mode which are operative to detect usage of a mobile phone. In such embodiments, a further detection system may be operative to communicate information to the portable detection system, which prompts the operator to begin monitoring a specific vehicle detected by the further detection system. Such communications may include the license plate/number captured of the further vehicle, images of the vehicle and/or any other information determined by the further detection systems. The operator may use the information provided by the further detection system (which may be displayed on the display screen of the portable system) to determine whether to pursue the vehicle and issue a ticket.

In further embodiments, the described portable detection system may be operative to use the communication system 1016 to communicate with a detection system mounted in a vehicle and/or an event data recorder (EDR) mounted in the vehicle. Information gathered from the EDR by the portable system may include evidence of mobile phone usage detected by a detection system mounted in the vehicle.

In another aspect of one or more system described herein, characteristics of the eyes of the user of the mobile phone may be detected and analyzed to determine whether the user is currently or has been previously using a cell phone. For example, the previously described portable detection system and/or another system (e.g., an application on a cell phone, or a detection system mounted in a vehicle) may be operative to use a camera directed towards a person's eyes to monitor the ability of the user to track objects with their eyes, to monitor how often a person blinks, pupil size, and/or any other characteristic of a person's eyes that can be detected with a camera. The system may be responsive to information captured by the camera to determine conditions of the person (e.g., fatigue, addiction to cell phones, substance abuse). For example, the system may be operative to determine if the user is able to track objects with their eyes relative a predetermined known level of tracking ability for a population of people that are not addicted to mobile phones and that are not under the influence of alcohol or other drugs. The system upon detecting that a user is not capable of tracking objects with their eyes as wells as the predetermined level may be operative to take one or more actions depending on the packaging of the system.

For example such an eye tracking feature may be integrated into the previously described portable detection system. When a police officer is evaluating whether a driver has committed a traffic violation as a result of using their mobile phone while drive (and/or as a result of alcohol or drug use), the police office may use the portable detection system to carry out an eye test with the driver. Such an eye test may include the system displaying a moving object on a display screen of the system, and the system monitoring the persons' ability to track the moving object. The processor of the system may then determine the delay associated with the user's eyes attempting to track the movement of the object on the display screen. The processor may also compare this determined delay to a predetermined known value or range of delays in order to determine if the person may be under the influence of alcohol and/or was using a mobile phone (which may degrade the ability of the person to track moving objects). The processor of the system may then be operative to output indicia on a display screen that is representative of the determination as to whether the user's eye tracking ability is degraded. The processor may also be operative to determine and display on the display screen whether a person's eyes are dilated, are excessively red, are blood shot, and/or have other characteristics representative of fatigue, addiction, and/or substance abuse. The police officer may use this displayed information when assessing whether to ticket and/or arrest the driver of the vehicle.

In a further example embodiment, these eye evaluating and/or tracking features may be integrated into an application that operates on a mobile phone or eyewear (helmet, goggles, eyeglasses worn by a user). For example, such an application may display the moving object on a front facing display to a person and monitor with a front facing camera, the user's ability to track the moving object with their eyes.

The application may also be operative to biometrically identify the person via facial and/or eye characteristics captured by the front facing camera of the mobile phone (or eyewear), in order to verify the identity of the person performing the eye test. Such an application may then operate in the processor of the mobile phone (or eyewear) to determine (as described previously) whether the person's ability to track objects with their eyes is and/or is not degraded. Information regarding the person's ability to track moving objects with their eyes (and/or other determined characteristics of the person) may be stored in a data store on the mobile phone (or eyewear) and/or uploaded to a remote server, in order to track changes in the user's ability to track objects with their eyes over time (and/or other determined characteristics of the person). Such information may be usable to assess improvement and/or degradation in overcoming mobile phone addiction or other conditions.

In a further embodiment, vehicles, machinery, and other equipment may be operative to remain in a disabled state until an eye test such as the described tracking test has been performed and has determined that the person's eye tracking ability is not degraded. For example, a person's vehicle may require such a test to be carried out on a person's mobile phone, eyewear, and/or a system integrated into the vehicle, prior to the vehicle operating to drive. A testing system integrated into the vehicle may include a camera and display device or a series of LEDs (for carrying out the test) mounted to a dash, sun visor, steering wheel, or other portion of the vehicle.

When carried out by a mobile phone, or eyewear, the vehicle may include a processor that is operative to communicate with the cell phone (e.g. via Bluetooth, NFC, RFID, or other wired or wireless communication) order to receive information from the mobile phone (or eyewear) that verifies that the user passed the eye test and/or that the person carrying out the eye test is an authorized user of the vehicle (e.g., via biometrics). If the authorized user is unable to pass the eye test, the processor of the vehicle is operative to prevent the user from driving the vehicle (e.g. starting the engine and/or placing the transmission out of park).

Such an eye test system integrated into the vehicle (rather than using a mobile phone or eyewear) may use a display screen mounted in the vehicle to display the moving object, and may include a camera positioned to monitor the eye movement of the user (and/or carry out biometric identification of the user). In another embodiment, the vehicle may include a series of horizontal and/or vertical LEDs that flash in one or more patterns to facilitate tracking of eye movement. A processor in the vehicle may be operative to evaluate the eye movement of a user to verify that the user's eye tracking ability is not degraded (and may also verify that the user is an authorized driver of the vehicle via biometrics) prior to enabling the vehicle engine to be started and/or to be driven. For example, the ignition of the vehicle may be inoperative to turn on the engine of the vehicle until the ignition receives a confirmation from the described processor that the user has passed the eye test.

Also in further embodiments, the eye test system (integrated into a vehicle) may be operative to monitor the eye tracking ability of the user while driving the vehicle in order to verify that the user's eye tracking ability does not become degraded while driving. For example, rather than having the driver following a moving object on a display screen, the system may be operative to monitor the eyes of the driver during normal driving operations, to verify that the user's ability to move their eyes while driving appears to be within expected ranges. Such expected ranges may be determined by the processor responsive to historical data captured by the eye test system of the driver driving the vehicle.

Also in further embodiments, the eye test system may be integrated into a detection system mounted external to a vehicle. As in previously described embodiments, such a detection system mounted adjacent a roadway (or other location), which includes an IR illuminator operative to break the glare of the glass of the vehicle, in order to capture images of the eyes of drivers of passing vehicles with a camera of the detection system. The processor in the detection system may be operative to monitor the eyes of the drivers of passing vehicles in order to determine if the driver's eyes have characteristics which correspond to use of a mobile phone, mobile phone addiction, and/or use of alcohol and/or drugs.

It should be appreciated that this described eye test system may be integrated with other types of equipment other than vehicle to serve as a key that unlocks the ability of the equipment to carry out one or more actions. For example, industrial equipment in a factory may require such an eye test to be carried out by an authorized user of the equipment, before the user is permitted by a processor in the eye test system to operate one or more features of the equipment.

As discussed above, the previously described portable detection system may be used by police to identify and ticket drivers of vehicles that are illegally using a mobile phone while driving. In a further embodiment, one or more features of this portable detection system may be carried out by an application operating on a mobile phone. Such an application may be used by authorized civilians to capture evidence (e.g. images, video, audio) of illegal usage of mobile phones by drivers of vehicles (and/or other type of illegal activity). For example, the user may use the application to capture an image of a driver holding a mobile phone while drive and an image of the license plate of the vehicle. The application may also be operative to include and/or integrate location data, time/date data, (determined by the mobile) with the captured images.

Such an application may be operative to upload the captured images, video and/or audio to a remote server, in real-time, at a scheduled time or when prompted by a user of the phone. The remote server may be operative to communicate the acquired evidence to appropriate law enforcement for purposes of issuing warnings and/or tickets to an address on record associated with the license plate of the vehicle depicted in the uploaded images. The remote server may also be operative to carry out facial recognition on the images in order to identify people depicted in the images.

In this described embodiment, the user of the application may be operative to create an individual account that is stored in one or more databases in operative connection with the server. Such an account may be used by the server to store the name and address of the user uploading the captured images. Such information may be made available to the police so that the person capturing the images may be contacted (if needed) to serve as a witness.

In addition, the server may be operative to track in the database the number of submissions of images for each account as well as the success rate of such images being used by police to issue tickets, carry out arrests, and otherwise solve crimes. Based on the rate that uploaded images are useful to police (and/or other criteria), user accounts may be rewarded points and/or other recognition data (stored in the data base). Such points or other recognition data may accumulate and be redeemed by users for prizes and/or monitory rewards.

In further examples, the server may be in operative connection with a web site. Such a web site may display the uploaded images. Such uploaded images may viewed by the public for purposes of solving crimes and/or recognizing users that have received awards and prizes for the information and images provided by users.

To further the usefulness of the information provided by the described mobile phone application, the application may also enable the user to upload additional information along with the captured images to the server. Such additional information may include information known to the user but not apparent from the captured images. For example, the user may be operative to enter the color, make, and model of the vehicle, the license plate of the vehicle, whether passengers were present in the vehicle, and/or any other information which may be useful to law enforcement.

In addition, the application operating on the mobile phone may also be adapted to work with eyewear (e.g. a helmet, goggles, glasses) to assist in capturing images. For example, such eyewear may connect via a Bluetooth connection to the mobile phone. The eye ware may include a camera operative to capture live video and a display operative to show the captured video to the user in real time. The user may then via suitable inputs to the eyewear (or other input device) control the application on the mobile phone to upload images captured by the camera on the eyewear to the remote server. Further the eyewear may be operative to display information on a display screen that is determined by a processor in the eye ware or the mobile phone regarding the usefulness of the captures images. For example the video may be processed in real time by a processor in the eyewear or the mobile phone to identify portions of the video that show a mobile phone and/or a license plate. Such information displayed to the user may be usable to verify that sufficient evidence has been acquired through use of the described application and eyewear. Further the eyewear may be operated by the user to zoom the camera in on features of the vehicle to enhance the visual detail of the images being captured.

In example embodiments of a detection system mounted in a vehicle (to detect usage of a mobile phone in the same vehicle), the at least one processor in the detection system may be operative to cause an output device to output signals corresponding to subliminal messages which encourage a driver of the vehicle to stop using a mobile phone. Such a subliminal message may correspond to a sensory stimuli below a driver's threshold for conscious perception of the message, but which is still capable of influencing the behavior of the user (e.g. to stop using the mobile phone). In example embodiments, such subliminal messages may be in the form of a fast or low volume audible sound which verbally conveys a message to “hang up”, “put phone down” or other command that encourages the driver of the vehicle to stop using the mobile phone. Although in some embodiments, the output device (e.g., a speaker) of the user interface may be operative to output the subliminal message, it should also be appreciated that further embodiments, may be operative to cause the mobile phone itself (e.g., the speaker of the phone) to output the subliminal message (e.g. via an interruption RF signal, Bluetooth communication and/or a network communication).

In example embodiments, the described systems may be powered via any available power source. However, it should be appreciated that in some applications of the described systems (such as systems mounted in a vehicle, prison, room, etc.) a physical power line, cable, or outlet may not be available. In such embodiments, the systems may include a power receiver device that is operative to receive power wirelessly for operating system components. For example, the power receiver device may correspond to an RF power receiver device that is operative to acquire electrical power from RF signals transmitted by an RF power transmitter device (mounted in another location in the vehicle or building). In further embodiments, the power receiver may be operative to harvest power from other RF sources (e.g., RF communication signals) in addition to, or instead of using RF transmitted from described dedicated RF power transmitter device.

Also, in further examples, the power receiver device may correspond to a vibration power receiver which is operative to convert mechanical vibrations (e.g., movement vibrations in a moving vehicle) to electrical energy. In addition, in another embodiment, the power receiver device may correspond to any other type of device that is capable of harvesting power from energy sources in the vicinity of the detection system (e.g., solar cells and wind turbines).

In these described embodiments, the power receiver device may be operative to charge a rechargeable battery with the acquired electrical energy. The other components in the detection system (e.g., the processor, and other components) may be powered via the battery. However, it is to be understood that example embodiments of the described power receiver device may directly provide power to the detection system without using a battery. Examples of RF power transmitter and receiver devices that may be used in example system include the Powercast and Powerharvester modules sold by Powercast Corporation in Pittsburgh, Pa.

As discussed previously, example embodiments of the detection system may be operative to detect the presence, usage, and/or location of a mobile phone responsive to mobile phone communications between the mobile phone and a cell tower. In addition, embodiments of the described system may be operative to detect the presence, usage, and/or location of a mobile phone responsive to shorter range communications transmitted from the mobile phone, such as Bluetooth communications, near field communications (NFC), wireless Ethernet signals, and/or any other type of mobile phone signal transmitted from the mobile phone. In these described examples, mobile phone signals may be transmitted to a cell tower, another portable device, a receiver in the vehicle, a server, or other type of communication device for purposes of carrying out phone calls, sending network data, downloading web pages, streaming video, sending SMS messages, or any other type of communications with another person or system.

In addition, in a further embodiment, the detection system may be operative to detect mobile phone communications specifically designed to be detected by the described detection system. In this embodiment, the mobile phone may include an indicator feature (implemented via software and/or an electrical circuit in the mobile phone) which is operative to cause the mobile phone to generate an indicator signal (such as an Ethernet network signal, Bluetooth signal, or other RF communication signal). The described detection system may include a receiver which is capable of detecting the indicator signal to determine the presence, usage, and/or location of the mobile phone.

In this described embodiment, the indicator feature in the mobile phone may be operative to cause the mobile phone to produce the indicator signal while the mobile phone is being used by a user in a manner that could distract the driver of the vehicle. Thus, the indicator feature in the mobile phone may generate the indicator signal when the phone is being used to make a phone call, SMS message, surf the web, play a game, or any other activity which requires user inputs to input devices of the mobile phone. The described indicator feature may be operative to detect usage of such input devices and in response thereto cause the mobile phone to transmit the indicator signal. However, it should be appreciated that at other times when the mobile phone is being safely used (to serve as a hands free navigation system), the indicator feature may be configured so as to not transmit the indicator signal.

Also, it should be appreciated that the indicator feature of the mobile phone may produce different types of indicator signals and/or include different data in the indicator signal, depending on the status of the phone. For example, the system may indicate the presence of the phone when not in active use (by a user) by emitting an indicator signal periodically or randomly (or by another pattern) that includes data indicative of the mobile phone being present but not being actively used. Further, when the device is being actively used (in a manner that could distract the driver) the indicator feature may cause the mobile phone to produce an indicator signal that includes data indicative of the active usage of the mobile phone. Such data of the active usage of the mobile phone may include the type of usage (e.g., cell phone call, web browsing, SMS messages). Also, data indicative of either the presence or active use of the mobile phone, may include other types of data such as GPS coordinates and/or any other information which is available to the mobile phone and may be useful to the detection system.

For example, the indicator feature may be operative to include GPS coordinates (acquired using the GPS in the phone) in the indicator signal. Also, the indicator feature may include any other types of data in the indicator signal such as the phone number of the mobile phone, the phone number being communicated with, names of applications being used, and/or any other information that is available to the phone. The described detection system may acquire such information from the indicator signal for purposes of logging and reporting usage of mobile phones for the particular location (e.g., vehicle, roadway, prison cell) being monitored by the detection system.

In an example embodiment, the indicator signal may be encrypted in a manner that only permits the detection system to uncover the information in the indicator signal. For example, the indicator feature could encrypt data in the indicator signal with a public key of the detection system. The processor in the detection system may have access to a corresponding private key in order to decrypt the information in the indicator signal.

The detection system may also use detected signal strength properties of the indicator signal to verify that the detected mobile phone is in the desired location being monitored. (e.g., vehicle, roadway, prison cell) and is not in some adjacent area (sidewalk, another vehicle etc.). Also, for indicator signals that include GPS coordinates, such GPS coordinates may be used by the detection system to verify that the mobile phone is in the desired location being monitored.

In addition, it should be understood that mobile phone signals other than the described indicator signal (such as phone calls through a cell tower) may also include GPS data, header data, and/or other types of data that is detectable by the detection system. Such embodiments of the detection system may be operative to uncover such data and use it to identify the mobile phone and/or verify that the mobile phone is in the desired location being monitored. For mobile phone signals that do not include GPS data, the detection system may use a plurality of antennas to carry out triangulation which identifies the location of the mobile phone transmitting the mobile phone signals. Embodiments of the detection system may also use both location data determined via triangulation and header data (or other data) in the mobile phone signal to identify, track, and/or monitor a mobile phone.

Also, it should be appreciated that some mobile phones may not include a GPS (that senses the location of GPS satellites) but may acquire location data from information provided by cell tower triangulation. Thus as used herein, location data (or position data) may correspond to GPS coordinates or any other type of data which is capable of indicating the location of a mobile phone.

In these described embodiments (that detect mobile phone signals or the described indicator signal), the detection system may include its own GPS (either in the same housing as the system, or an externally located GPS in a connected system or subsystem). The described detection system may determine whether the location data from its own GPS (which is not the GPS in the mobile phone) and the location data in the detected mobile phone signal (e.g., which was acquired by the GPS in the mobile phone) specify locations that have a predetermined relationship (e.g., are within a predetermined distance of each other).

For example, if the detection system corresponds to a stationary or moving system that detects use of mobile phones in vehicles in a roadway, the processor in the detection system may use its determined location to calculate the coordinates for locations in the roadway being monitored (via one or more cameras). The system can then monitor location data in mobile phones to determine which mobile phone signals being detected are likely (given the errors of the location data) within the calculated locations in the roadway being monitored at times when images of one or more vehicles are being detected/captured by the cameras of the system. Correspondence between the determined location of a mobile phone signal in a monitored roadway when a vehicle is present in the roadway can be used to corroborate that a mobile phone call (or other mobile phone communication) was taking place in the vehicle by the driver. It should be appreciated that this described process for determining the location of the mobile phone signal using GPS data may also be used in combination with previously described processes for determining the location of the mobile phone signal, such as by using antenna array and triangulation.

Also for example, if the detection system corresponds to a system located in a vehicle (or a building) that detects use of the mobile phones in the same vehicle (or building), the processor in the detection system may use its determined location to calculate the coordinates for locations in the vehicle (or building) being monitored. The system can then monitor location data in mobile phone signals to determine which mobile phone signals being detected are likely (given the errors of the location data) within the same vehicle (or portion of a building) as the detection system and/or are originating from a mobile phone adjacent the detection system.

In these described examples, the processor in the system may determine whether the location data within the mobile phone corresponds to (or is within a predetermined distance of) a predetermined location (e.g., a location in the roadway, vehicle, or room) determined using the location data from the detection system. However, it should be appreciated that the processor of the described system may use other features of the location data in the mobile phone signal and from the GPS in the detection system to corroborate that a detected mobile phone signals originates from a mobile phone in a predetermined location.

For example, in cases where there may be large errors between the location data and the actual physical locations of the mobile phone and/or the detection system, the processor of the system may be operative to monitor the location data to determine velocity, traveling direction, tracks (e.g., a plurality of positions over a time period), and changes in velocity, to determine that the detected mobile phone signal originates from a particular vehicle in the roadway, or in the same vehicle in which the detection system is located.

Also, it should be appreciated that the described mobile phone signal (or an indicator signal) may include data indicative of the mobile phone number of the mobile phone. An example embodiment of the detection system may include a data store comprising one or more mobile phone numbers to monitor. When the mobile phone number detected in the mobile phone signal (or in the indicator signal) matches a mobile phone number in the data store, the described detection system may be operative to begin logging and/or reporting usage of the mobile phone.

In one or more of the previously described embodiments, one or more cameras may be used to capture images of vehicles and/or persons using mobile phones in vehicles. It should be appreciated that one or more of such cameras may be mounted to mechanisms operative to articulate the direction of the camera and/or zoom in/out the lens of the camera between relatively different telephoto and/or wide angle views. Such a mechanism may corresponds to a robot arm, motorized camera tripod, or any other mechanized system that is operative to orientate a camera in different directions.

In an example embodiment, the processor of the detection system may cause the camera to move and/or zoom its lens responsive to a determined location of a mobile phone signal in order to capture images of the mobile phone, vehicle, and/or person associated with the source of the mobile phone signal. Also, it should be appreciated that the camera may be moved to follow the location of the driver in the vehicle and/or other features of the vehicle (such as the license plate) based at least in part on imaging recognition software in the system evaluating in real-time the location of the driver and/or other features of the vehicle in the video stream from the camera.

As discussed previously, the described detection systems may be operative to cause an output of information indicative of the detection of a mobile phone being used in a predetermined location such as in a particular roadway, vehicle, building, prison cell, or other location. As discussed previously, such information may be used to trigger an alarm or notification of the detection at the location of the detection system and/or at a remote location (e.g., at a monitoring system). Also, it should be appreciated that in some embodiments, the notification at the location of the detection system may have a form that is visible to a third party.

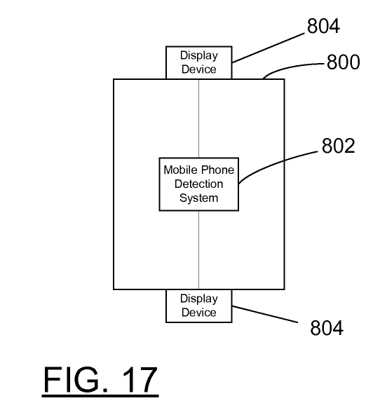

For example, as illustrated in FIG. 17, a detection system 802 may be operative to cause at least one output device such as a display device 804 to begin emitting light, or a pattern of lights which is visible to third parties. In this example, the detection system 802 and display device 804 may be mounted to or adjacent an object 800 (e.g., vehicle, equipment, building) at which a person may use a mobile phone to make a mobile phone call, send an SMS message, or other communication.

For example, the object 800 may correspond to a vehicle (e.g., a land vehicle, a water craft, an automobile, a truck, a train, a bus, a trolley, and a ship). When the detection system detects use of a mobile phone in an adjacent location in the vehicle (e.g. near the driver's seat), the detection system may activate the display device to warn drivers of other vehicles or bystanders outside the vehicle that a mobile phone is being used. Such a display device for example may be mounted to the front end and/or rear end of the vehicle. For example the display device may be mounted adjacent a license plate or adjacent another portion of the rear end of the vehicle, such that a person behind the vehicle can directly view both the license plate and the display device. Also in further embodiments, the display device may be mounted on the roof of the vehicle, adjacent a window, and/or adjacent another portion of the vehicle. When a third party sees the display device emitting light (as a result of a detection of usage of a mobile phone in the vehicle), the third party may proceed with caution and/or may notify law enforcement. Also, in further embodiments the display device may be mounted inside the vehicle such that the driver and/or passengers (e.g., of a bus, train, trolley, ship) inside the vehicle can view the display device.

The display device may be operative to emit light in one or more different colors. For example, the display device may include a plurality of LEDs operative to emit light directly (or through a colored plastic) with one or more colors (e.g., blue, yellow). Over time the color(s) or pattern of the light from of the display device may become known to be associated with use of a mobile phone. In further embodiments, the display device may be operative to display one or more graphical symbols and/or text which convey that a mobile phone is being used in the vehicle. For example, the display device may emit light in the pattern of a shape of a mobile phone or other symbol representative of a mobile phone. In example embodiments, the display device may hold the light steady, flash the light, strobe the light, and/or change the intensity and/or colors of the emitted light.

In this described embodiment, the display device 804 may be connected via wires to the detection system 802, in order to receive power which controls the display of light from the display device. However, in alternative embodiments, the display device may be powered via an electrical connection associated with the electrical system of the vehicle. The detection system may then through wires or wirelessly send signals to the display device which turns on and off the display of light from the display device.

Also, in another embodiment, many display devices capable of receiving a wireless activation signal from the detection systems of many different vehicles may be installed along a roadway. Such roadside mounted displays may display a warning message that is visible to the driver of the vehicle (from which the activation signal is sent). Such a warning message in a roadside display may indicated that a nearby vehicle is using a mobile phone while driving, in order to warn the driver to stop using the mobile phone and/or to warn drivers in adjacent vehicles that a nearby vehicle is using a mobile phone.

Also, it should be appreciated that this described third party warning system associated with the detection system may be applicable to other types of objects 800 besides vehicles. For example, companies with industrial equipment (stationary or moving) may include a detection system and a display device mounted thereon or adjacent thereto to warn others when an operator of the equipment is using a mobile phone. Also, this described detection system and display device may be mounted inside buildings and rooms to warn third parties that mobile phone usage is taking place in the building or room. In addition the display device may be remote from the detection system and be adjacent the third party. For example, the display device may be mounted to a wearable wrist band, ring, or other object that is operative to display a warning message responsive to detection of a wireless signal from a detection system.

It should be appreciated that in some embodiments described herein, a person may attempt to disable the detection system. Thus, example embodiments of the detection system may be operative to carry out one or more tests to verify that the detection system continues to be operative to detect mobile phones. For example, if the user has the ability to access the detection system, the user may unplug the electrical power to the detection system. To detect this, the detection system may be operatively programmed to periodically store a current time in a data store on the device (e.g., in a log file). The detection system may be operative to communicate the data representative of the stored times to a monitoring system (e.g., a server including at least one processor) for evaluation of the operation of the detection system. The monitoring system may include monitoring software that is operative to evaluate the time information communicated from the detection system. Discrepancies (e.g., gaps in the stored time data) uncovered by the monitoring software may cause the monitoring system to indicate that the detection system may have been disabled and/or tampered with.

In addition, a person could possibly move the detection system to another location (while leaving it enabled). As discussed previously, embodiments of the detection system may include a GPS and may include GPS location data in the information communicated periodically to a monitoring system. The monitoring system (responsive to monitoring software) may be operative to evaluate GPS data received from a detection system to verify that the detection system remains in a predetermined location (e.g., in a building, adjacent equipment, or adjacent a roadway), or verify that the detection system moves (in a vehicle) to predetermined locations in an expected pattern (e.g., to and from home and/or a place of work).

In addition, a person could possibly place shielding material (e.g., a copper mesh, aluminum foil, or other material) or a jamming device adjacent the antenna(s) of the detection system, in order to interfere with the ability of the detection system to detect mobile phone signals. An example embodiment of the detection system may be operative to periodically perform a self-test to verify that the antenna(s) of the detection system are working properly and are capable of detecting mobile phone signals. For example, the detection system may be operatively programmed to initially detect, and store in a data store, reference measurement data representative of detected background signals detected via its antenna(s).

Such reference measurement data may be captured when the detection system is initially installed, initially powered on, in response to an input through an input device of the detection system, and/or at other times. The detection system may then be operatively programmed to periodically acquire further (i.e., more current) measurement data representative of detected background signals detected via its antenna(s), for comparison to the reference measurement data. Such background signals may correspond to radio frequency signals, magnetic field strength, and/or any other electrical/magnetic properties of the antenna that are capable of being detected by the detection system.

The detection system may be operative to determine discrepancies between the current measurement data and reference measurement data that may be representative of shielding or jamming of the detection system. For example, the antenna may be operative to detect an external radio signal emitted from a transmitter installed in the general vicinity of the detection system, and/or transmitted from a third party system (e.g., AM radio broadcast). The reference measurements may be captured while such an external radio signal is active. When current measurements fail to detect the external radio signal (or detects a weaker external signal), the detection system may be operative to transmit a further communication to the monitoring system, which signal is indicative of the unit being possibly tampered with or having a detection problem (i.e., a decrease in ability to detect mobile phone signals).

In further embodiments, the detection system may include a transmitter and may output a predetermined radio frequency signal during the capture of the reference and current measurements. Detected changes in the properties of the detection of the transmitted signal between the reference and current measurements may cause the detection system to transmit the further communication to the monitoring system which is indicative of a detection problem. In alternative embodiments, the detection system may be operative to communicate the reference and current measurement data to the monitoring system and the monitoring system may determine whether the detection system may have a detection problem.

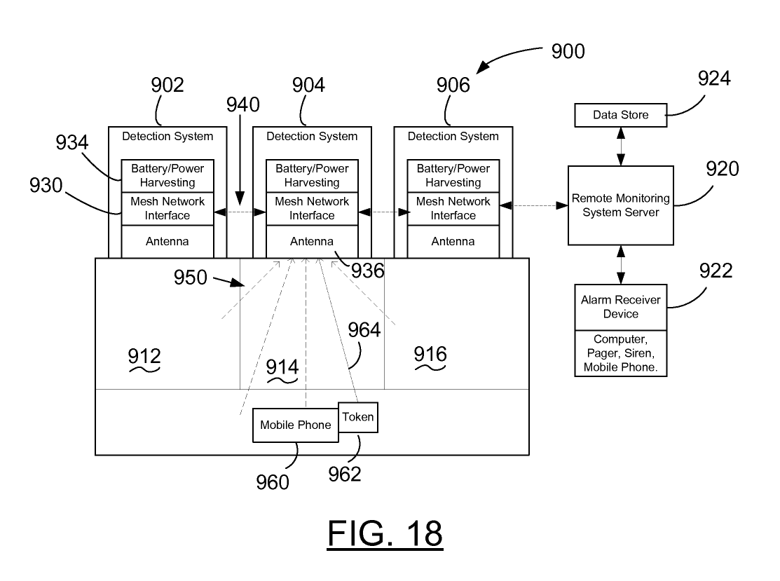

As discussed previously, embodiments of the described detection system may be employed in a prison system (or other type of building). FIG. 18, shows an example of a portion of a prison 900. Such a prison may include a plurality of prison cells 912, 914, 916 (or other rooms). To individually determine which prison cells may include use of a mobile phone therein, each prison cell may include a respective detection system 902, 904, 906 (e.g., mounted outside a window or other location). In this example, the detection system may be battery powered and may be operative to enter a low power sleep/hibernation mode/state (to preserve battery life), after a predetermined amount of time in which mobile phone activity is not detected. In an example sleep state, the detection system may be configured so as to provide no electrical power from the battery to the processor. However, in other examples of sleep states, the detection system may provide a relatively lower level of battery power to the processor compared to levels of battery power needed to process mobile phone signals.

As discussed in U.S. application Ser. No. 12/433,219 filed Apr. 30, 2009, the antenna of the detection system may include a passive antenna configured to generate a signal from a sufficiently strong mobile phone communication, which generated signal is sufficiently strong to power a circuit in the system that awakens the system from the sleep mode (which provides power or relatively more power to the processor). After being awakened from the sleep mode, the detection system may then begin operating using power from the battery to carry out one or more of the previously described functions of example embodiments of the detection system. Such functions for example that occur when the system is awakened from the sleep mode (but which do not occur during the sleep mode) may include transmitting a notification to a monitoring system 920 operative to generate an appropriate alarm communication representative of the presence of mobile phone use.

In addition, as discussed previously, embodiments of the detection systems mounted in the prison (or other location) may acquire energy to charge a rechargeable battery via power harvesting circuits 934. As discussed previously, such power harvesting circuits may include a power harvesting receiver operative to harvest RF signals from the environment or from a dedicated RF transmitter. Also, in other embodiments, the detection system may be powered via electrical lines associated with the prison building, and/or powered from a network cable.

Also, as discussed previously, the detection system may include a directional antenna 936, operative to detect mobile phone signals transmitted on one side of the antenna (or subset of angles around the antenna) at a particular distance, that would not be detectable by the antenna when transmitted on an opposite side of the antenna (or other subset of angles around the antenna) at the same distance. For example, as shown in FIG. 18, the antenna 936 may be orientated to be more sensitive to the detection of mobile phone signals in the area 950 of a prison cell 914 compared to locations in adjacent prison cells 912, 916, outside the prison cell, or on the side of the antenna opposite the prison cell.

Also, example embodiments of the detection system may include a band pass filter that is operative to detect uplink frequencies that are transmitted by mobile phones to communicate with a cell tower. The detection system may be operative responsive to the detection of such uplink signals in order to determine that mobile phone usage is taking place in the adjacent prison cell.

As discussed in U.S. application Ser. No. 12/433,219, embodiments of the detection system may include a wireless communication device in order to communicate data indicative of the detection of mobile phone usage in a prison cell to a monitoring system. In an example embodiment, hundreds of detection systems (one for each prison cell, for example) may be installed in the prison. In such embodiments, multiple access points may be employed to enable all of the detection systems to communication through a wireless network with a monitoring system (e.g., a server). However, in alternative embodiments, the detection systems may be configured to form a mesh network 940, which communicates with the remote monitoring system 920. In a mesh network, each detection system may include a mesh wireless network interface 930 which enables the detection system to communicate with the mesh network interface of other detection systems. Thus, rather than communicating directly with a dedicated wireless access point and/or a wired network, many of the detection systems may communicate messages wirelessly through other detection systems to reach a wireless access point and/or a wired network in communication with the monitoring system 920. Examples of mesh network interface technology that may be incorporated in the described detection systems include network interfaces/firmware/software compatible with the IEEE 802.11s standard. However, it should be appreciated that other mesh network components and technologies may be used such as SolarMESH, SMesh and/or other types of P2P network technologies.

In a prison system 900 or other building in which detection systems are employed, some personnel working in the prison or other building (e.g., such as a guard) may have a need to use a mobile phone 690 near the detection systems, without triggering the detection systems to communicate an alarm notification to a monitoring system 920. To enable selective mobile phone use without triggering an alarm, an example embodiment of the detection systems may be operate to determine that a detected mobile phone communication is permitted, and in response not send an alarm signal to a monitoring system.

In an example embodiment, the detection system may be operative to acquire header information or other data in the detected mobile phone signal (or an indicator signal) to determine if the detected mobile phone signal is authorized to be used. In this embodiment, the detection system may communicate the detection of the mobile phone along with the detected data to the monitoring system 920. The monitoring system 920 may then operate to determine whether the detected data corresponds to an authorized mobile phone (that is permitted to be used without triggering an alarm) by comparing the detected data to data stored in a data store 924.

In a further example embodiment, the detection systems may be operative to detect a secondary signal indicative of a person being permitted to use a mobile phone without triggering an alarm. Such a secondary signal may correspond to an RF signal 964 detectable by a receiver in the detection system (that is different than the detected mobile phone signal). Such a secondary RF signal 964 may be transmitted from a transmitter associated with a token 962 carried by a user using the detected mobile phone. Such a token may include an RFID chip/circuit or other RF transmitter that emits the secondary RF signal. In example embodiments, the token may correspond to a card, badge, dongle, ring, hard hat, or any other object that is capable of transmitting the secondary RF signal. Further, the token may be included in or be mounted to the mobile phone of an authorized user. In other examples, the secondary RF signal may correspond to an RF signal generated by the mobile phone such as a Bluetooth signal or a wireless network signal (that is configured to emit data usable to verify that the mobile phone is authorized). For example, such a secondary RF signal transmitted by a mobile phone may correspond to the previously described indicator signal.

In example embodiments, the secondary RF signal 964 may include a unique ID or other data which is detectable by the detection system 904. In an example embodiment, the detection system may be operative to verify the unique ID or other data itself as corresponding to an authorized mobile phone, and in response not send a notification to the monitoring system 920. However, alternatively, the detection system 904 may be operative to send a notification of the detected mobile phone along with the data detected from secondary RF signal 964. In this alternative embodiment, the monitoring system 920 may be operative to evaluate the data detected from the secondary RF signal and determine whether an alarm should be triggered.

In further embodiments, the detection systems throughout the prison (or other building) may be operative to send data received from secondary RF signals 964 on a continuous basis (even when mobile phone signals are not detected). The monitoring system 920 may use such data to track the location of personnel in the prison or other building.

In addition, it should be appreciated that the monitoring system may be operative to monitor detection systems that appear to have died and are in need of maintenance or replacement. For example, each detection system may be operative to periodically send a notification to the monitoring system indicating that the detection system is working properly. As discussed previously, notifications from detection systems may include a unique ID (and/or GPS location data) in order for the monitoring system to identify and distinguish one detection system from another. The monitoring system 920 may include a data store 924 including data representative of installed detection systems, and may be operative to determine when a known detection system has failed to communicate a notification signal in a predetermined time period that is indicative of it working properly. In response to this determination, the monitoring system may communicate an alarm signal to appropriate personnel, which signal identifies the location of the detection system that may need new batteries or other maintenance.

Also, it should be appreciated that some embodiments of the detection system may not include a GPS. When such units are installed in the prison, the installed location of the detection system may be stored in correlation with its unique ID (serial number, and/or a user assigned ID) in a data store 924 associated with the monitoring system. Such stored location information may be used by the monitoring system to identify a location of a detection system that has sent a signal indicating the detection of a mobile phone or the detection of a secondary signal. Such stored location information may also be used to identify the location of a detection system that has failed to send a notification indicating that it is working properly.

In addition, in a prison or other embodiment with multiple adjacent detection systems, it should be appreciated that a mobile phone communication may be detected by more than one detection system (e.g., in adjacent prison cells). In example embodiments, the detection systems may be operative to communicate data to the monitoring system that is indicative of the detected power level of the mobile phone signal detected. When multiple detection systems notify the monitoring system of a mobile phone detection, the monitoring system may be operative responsive to the location data associated with each detection system and the power levels communicated from each detection system, to determine which of the detection systems is likely closest to the detected mobile phone. The monitoring system may then issue an alarm that includes the location (e.g., a particular prison cell or other room) of the detection system that is most likely closest to the detected mobile phone.

In addition, it should be appreciated that embodiments that involve vehicles may use a similar technique to determine that a mobile phone is being used by the operator of the vehicle (e.g. a driver of the vehicle) and not a passenger or person outside the vehicle. For example, a detection system mounted in a vehicle (e.g., automobile, bus, trolley) may include a plurality of spaced apart directional antennas orientated to detect mobile phone signals in different respective locations including a first location adjacent the operator's seat and one or more second locations that are farther from the first location than the first antenna (e.g. a location adjacent a passenger seat, a bus/trolley door). The processor in the detection system may be responsive to the respective signals from each respective antenna (e.g. the relative differences in power levels of the detected mobile phone signal for each antenna) to determine when a detected mobile phone signal is more likely being transmitted from the first location adjacent the operator's seat than a second location farther from the first location than the first antenna. When the detection system determines that the detected mobile phone signal is more likely being transmitted from the first location adjacent the operator's seat, the detection system may be operative to cause a display device to emit a warning light, send an alarm communication to a remote monitoring system, and/or carry out another one of the functions described herein when use of a mobile phone is detected.

To communicate alarms and problems (e.g., detected mobile phones, low or used battery levels, detection problems), example embodiments of the monitoring system 920 may be in operative connection with one or more alarm receiver devices 922. Such alarm receiver devices may include computers, monitors, displays, pagers, sirens, flashing lights, mobile phones, tablets, printers, faxes, databases, and/or any other device including (or corresponding to) an output device that is operative to output information about the alarm to a human capable of handling the alarm. It should be appreciated that alarm notifications may be communicated via e-mail, SMS messages, phone message, electrical lines, network signals, wired/wireless communications, and/or any other form of communication to which the alarm receiver devices are capable of communicating.

In a further example embodiment, one or more portions of the previously described embodiments may be employed in a system that is operative to directly interfere with and/or discourage a user from using voice communications with a mobile phone. In this described example, an apparatus may be operative to detect the user's voice (while talking on the mobile phone) and may cause an audio output device to output an audio output (perceptible consciously and/or subconsciously by the user) corresponding to the detected user's voice. The apparatus may cause the audio output to be delayed by many nanoseconds or milliseconds (e.g., 10-100 ms.) or other sufficient amount to cause the user to discontinue talking and/or using the mobile phone. This delay may be a generally constant delay or may be a variable delay (increasing and/or decreasing) while the user talks responsive to a predetermined or random pattern.

In an example embodiment, the audio output corresponds to a delayed auditory feedback (DAF) which may be correspond to an echo of the user's voice as the user talks on the mobile phone. In example embodiments, the amount of time for which the delayed auditory feedback is delayed relative to the user's detected voice, may be sufficient to cause degradation in the ability of the user to continue speaking clearly and/or may cause the user to stop speaking into the mobile phone. In example embodiments, the system may cause the delayed auditory feedback to continue for several seconds, stop for several seconds and then continue again in a symmetrical or random periodic manner while the phone call is active. In other embodiments, the delayed auditory feedback may be continuous while the phone call is active. In further embodiments, the characteristics of the delayed auditory feedback (e.g., amount of delay, volume level, and/or any other characteristics) may increase, decrease, and otherwise may be change while the call is active.

In one or more example embodiments, the audio output device (e.g., a speaker or other type of device that outputs sound) may be external to the mobile phone and may be operated by a detection system (also external to the mobile phone) that is capable of detecting the usage of the mobile phone. Such a detection system may also include an audio capture device (e.g., a microphone) capable of capturing the voice of the user talking on the mobile phone for use in generating the delayed auditory feedback.

Also, in one or more example embodiments, the audio output device may correspond to one or more of the speakers in the mobile phone, and the apparatus that detects usage of the mobile phone and that causes the delayed auditory feedback may correspond to the mobile phone itself. Also, the audio capture device used to capture the voice of the user for generation of the delayed auditory feedback may correspond to a microphone included in the mobile phone.

In embodiments in which the described features are carried out by the mobile phone itself, the mobile phone may include an integrated and/or downloaded application (operative in a processor of the mobile phone) that causes the delayed auditory feedback to be generated by the mobile phone. Such an application may be used in the treatment of cell phone addiction. For example, the application may include features which enable the application to monitor (including storing monitored data in a data store) the usage of the mobile phone for use with evaluating any improvements (e.g., a reduction of usage of the mobile phone relative a determined base line). The application may also be operative to evaluate and display usage trends during predetermined time periods (e.g., during school hours, work hours) and/or in predetermined locations (e.g., while driving a vehicle, at a place of work, at a schools). The application may also be operative to report such monitored usage data to a remote server for evaluation and display via a web page to the user or other parties (e.g., parents, treatment centers, a court, insurance company). Also, for example, the application may be operative to issue reports that are coded appropriately with insurance codes associated with the treatment of cell phone addiction in order to streamline the payment by insurance companies of fees associated with use of the described applications and systems for treating mobile phone addiction.

The application in the mobile phone may also be operative to determine when to output the delayed auditory feedback and the characteristics of the delayed auditory feedback by the audio output device responsive at least in part to stored data and/or signals/information detected by the mobile phone (e.g., signals and/or information from a, WiFi, NFC, Bluetooth, infrared light, sounds, timer, and/or any other types of signals/information detectable by the mobile phone). For example, GPS signals indicating a location in a predetermine geographical area, or indicating a velocity above a predetermined threshold, may trigger the application in the mobile phone (or an external detection system) to begin outputting the delayed auditory feedback upon detection of a voice call using the mobile phone. Similarly, a determined current time/date corresponding to predetermined schedule data may trigger the application in the mobile phone (or an external detection system) to begin outputting the delayed auditory feedback upon detection of a voice call using the mobile phone.

In addition, an example embodiment may include an indicator device mounted to the user (e.g., court-mandated arm or ankle bracelet) or in a particular location (e.g., adjacent a driver's seat of a vehicle, a place of work). Such an indicator device may be operative to output one or more different types of signals (detectable by the mobile phone) which trigger the application in the mobile phone to begin outputting the delayed auditory feedback upon detection of a voice call using the mobile phone. Such signals from an indicator device may further indicate one of a plurality of modes of operation of the application regarding the described delayed auditory feedback and other outputs that discourage usage of a mobile phone. For example, the application may include several modes of operation such as: a first mode that may be considered annoying to the user but may have a relatively low probability of making the user speak less clearly; a second mode which has that has a relatively high probability (compared to the first mode) of making the user speak less clearly; a third mode which as a relatively higher probability (compared to the first and second modes) of making the user incapable of speaking clearly; and a fourth mode in which the mobile phone call is not permitted to be established by the mobile phone. It should be appreciated that the described application may include other or different modes. It should be appreciated that the application may include exceptions for these different modes, to enable the user to speak clearly when making calls to a 911 service and/or other configurable predetermined phone numbers.

Also, the described features of the application may be configurable in a settings menu, which menu may be password protected. Disabling or uninstalling the application may also be protected by a password. In addition, one or more of the described modes, and/or different or additional modes, may include features which cause the mobile phone to limit the length of a call, number of calls, and number of text messages, during configurable times periods and/or for particular days of a calendar. In addition, the characteristics (e.g., volume level, duration of delayed auditory feedback, amount of auditory feedback delay, time periods between outputs of delayed auditory feedback) of the previously described modes may be adjustable in the setup menu. Further, the application may include warnings message and other information displayed on a display screen of the phone or outputted through a speaker of the phone, regarding the operation and/or status of the application.

In the previously described list of example modes, the first example mode may not include delayed auditory feedback, but rather may include an alarm or warning sound, static, white noise, a subliminal message, or other auditory feature which encourages the user to end the phone call. Also, in this example, the described third example mode may include delayed auditory feedback with an amount of delay that is capable of causing significant disruption in the ability of a user to speak clearly or to speak at all. Such a delay may for example be in the range of 30 ms to 50 ms. Also, in this example, the described second mode may also include delayed auditory feedback, but may be generated with a delay in a range below 30 ms or between 30 ms and 50 ms or above 50 ms, which may cause relatively less degradation in the ability of a user to speak clearly (compared the range chosen for the third example mode). It should be appreciated that the order and characteristics of these modes is exemplary, and alternative embodiments may include different types, order, and different characteristics for these different modes.

In example embodiments, the indicator device may include a user interface (e.g., buttons, switches, touch screen in operative connection with a processor) to enable which of several modes the indicator device is capable of outputting to the mobile phone. The indicator device may include a physical lock (e.g., a key lock which provides access to a physical user interface buttons/switches) and/or an electronic lock (e.g., an interface protected by a password or PIN) in order to prevent unauthorized modification to which mode the indicator device outputs. In further embodiments, the indicator device may not include a built-in user interface. Rather, it may simply include a communication device that allows it to be configured via a wired a wired (e.g. a USB port) or wireless (e.g. WiFi, NFC, Bluetooth) connection with an external device (e.g. a cell phone, computer, server) which is operative to configure the indicator device.

The described indicator device may correspond to a detection system, which may be operative to receive wireless signals from the mobile phone, which signals (e.g., a confirmation message) indicate/confirm that the mobile phone has installed thereon (and is capable of executing) the application which produces delayed auditory feed back during a user's voice call. If the detection system is unable to verify that a mobile phone has an application which produces delayed auditory feedback, the detection system may place itself into a mode that is operative to cause delayed auditory feedback to be generated externally of the mobile phone in response to the detection of a user making a voice call with a mobile phone. In this example embodiment, the detection system may include one or more of the configurable features described previously with respect to the application on the mobile phone that generates delayed auditory feedback.

Such an example detection system (with or without an indicator device), is operative to prevent or at least minimize a user's attempt to circumvent generation of delayed auditory feedback, by using a friend's mobile phone, when the mobile phone is used in a location (e.g., adjacent a driver's seat of a vehicle or a place of work or other places) with a detection system. Thus when a mobile phone is detected (and confirms that it has the described application), the detection system may be operative to instruct the mobile phone to place itself into a mode that provides the delayed auditory feedback (rather than activating the delayed auditory feedback features of the detection system). However, when the detection system detects an unknown mobile phone (that does not return a confirmation message), the detection system may itself cause an audio output signal to be generated and directed to the location of the mobile phone, which audio output signal includes the delayed auditory feedback. As discussed previously, the described detection system may include an audio capture device (e.g., a microphone) capable of capturing the voice of the user talking on the mobile phone, in order to generate the delayed auditory feedback.

In this embodiment the detection system may be paired to the mobile phone (e.g., using Bluetooth pairing with a PIN, digital certificates, or other form of mutual wireless identification/authentication). The detection system may be operative to monitor and store in a data store (and/or report to a remote server) the presence and/or usage of the paired mobile phone and/or a detected unknown mobile phones. The remote server may display the information reported by the detection system in a web page for use by a third party in order to confirm usage of the particular mobile phone that includes the described application operate to generate delayed auditory feedback.

However, it should be understood that in alternative embodiments, the mobile phone may not need to be paired with the detection system. Rather, the application may continually monitor for signals representative of the presence of a detection system (via monitoring for signals from the described indicator device/feature of the detection system), and in response thereto may communicate a confirmation message (e.g., a digitally signed message) which enables the indicator device to verify that the mobile phone is running the described application operative to generate delayed auditory feedback.

It should also be understood that the described detection system may also include the capability to unlock a further component responsive to verification that the mobile phone is executing the described application. For example, the indicator device may be installed in a vehicle, at a piece of machinery, or other device that the user of the mobile phone whishes to use (e.g., drive, operate). When a mobile phone is detected by the indicator device/detection system, the other device (e.g., vehicle or other machine) may be configured to prevent operation of at least portions of the other device (e.g., driving the vehicle, operating the machine) unless the indicator device verifies that the detected mobile phone includes the described application.

In a further example embodiment, the detection system may be operative to push the application to the mobile phone. For example, when the mobile comes into range of the detection system, an RF signal (transmitted from the detection system) may prompt the mobile phone to display a notification message requesting an application associated with the detection system to be downloaded and installed on the mobile phone. The user, through operation of the interface on the mobile phone may then download/install/execute the application from the detection system. The executing application may then wirelessly cause the mobile phone to confirm with the detection system that the application is installed and is operating. The detection system may then operate responsive to this conformation (e.g., unlock operation of the vehicle or other equipment; disable external activation of delayed auditory feedback, or any other action). Also it should be appreciated that the application pushed to the mobile phone by the detection system may or may not have features which cause the mobile phone to produce delayed auditory feedback, but rather may have other features described herein related to preventing or at least minimizing use of a mobile phone while driving and/or using other types of equipment.

In this described embodiment, the detection system may use speakers integrated into adjacent systems. For example, when the described detection system is mounted in a vehicle, the detection system may be in operative connection with the sound system of the vehicle, and may cause the sound system to output the delayed auditory feedback. In further embodiments, the described detection system may be in operative connection with a hands-free mobile phone control system integrated into the vehicle which uses Bluetooth to enable calls through a paired mobile phone. Such a hands-free mobile phone control system may include a microphone built into the vehicle, which may be used by the described detection system to capture the voice of the user for generation of the delayed auditory feedback. Such a detection system may also be operative to determine use of the mobile phone to make a call responsive to information provided by the hands free mobile phone control system.

As in previously described embodiments, the detection system may be operative to report such mobile phone usage of the unknown mobile phone to a remote server. The reporting of the mobile phone usage may also include reporting any other data capable of being determined by the detection system such as the time, date, location (determinable by a GPS or pre-programmed into the detection system device). For example, the detection system may be operative to identify the phone via identification data includes in a confirmation message. For unknown mobile phones, the detection system may include a mobile phone signal receiver device capable of detecting the mobile phone signals communicated by the mobile phone to a cell tower or other type of network. Such mobile phone signals may include data (e.g., an identifier for the phone) for which the indicator device maybe operative to capture and report to the remote server.

In addition, the detection system may be operative to determine that the detected at least one mobile phone signal originated from a predetermined location. For example, as in previously described embodiments, a processor in the detection system may be configured to determine that the detected signal has characteristics such as sufficiently high signal strength, duration, source movement and/or other characteristics which indicate that it originates from a particular predetermined location near one or more antenna of the mobile phone signal receiver device. Also, the detection system may be configured to evaluate the detected mobile phone signal to determine that the detected signal corresponds to an ongoing voice communication, Internet access, or other human-involved activity with the mobile phone generating the detected mobile phone signal. Also, the detection system may include other receiver devices (e.g., a microphone, camera) capable of capturing other types of signals (e.g., the voice of the person talking on the mobile phone; the visual presence of a user talking on a mobile phone) which can be evaluated and used by the detection system to verify that the detected mobile phone is being used to make a voice call from a predetermined location (e.g., adjacent a driver's seat of a vehicle, or a place of work or other placed location). The detection system may also be operative to report the captured signals (e.g., audio or video/pictures) to the remote server.

Example embodiments of the detection system may include a data store (e.g., permanent and/or portable flash memory) in which the indicator device is operative to store detected and determined information regarding one or more detected usages of mobile phones. The detection device may also include a network communication device capable of wireless communicating the data to the remote server. Such a network communication may correspond to a mobile phone network communication device, a WiFi communication device, or any other type of network device capable of communicating with a remote server. It should be appreciated that a detection system having only a WiFi communication device may only be able to communicate with the remote server when it is in the vicinity of a local network the device is configured to automatically connect with. Thus when the detection system is mounted in a vehicle or is integrated into a bracelet worn by a user (or other package), when the vehicle/user returns to a location with a compatible wireless network, the detection system may be operative to automatically connect to the network and begin uploading the data stored in the data store of the detection system to the remote server. In addition, or alternatively, when the vehicle/user comes into range of a compatible wireless network, the detection system may be operative to receive a wireless signal through the wireless network interface device, which wireless signal is indicative of a request that causes or enables the detection system to begin sending through the wireless network the information from the data store that includes data representative of the detection of the at least one mobile phone signal. Further, when the detection system comes into range of a compatible wireless network, the detection system may be operative to update its configuration information with data downloaded from the remote server. Such a remote server may provide web pages which enable a third part (e.g., a parent, court, employer, treatment center) to update the manner in which the detection system operates and/or generated delayed auditory feedback.

In example embodiments where the detection system is mounted in a vehicle or other location, an example embodiment may include providing electrical power to the detection system by transmitting a radio frequency signal from a radio frequency power transmitter device mounted in the vehicle remote from the indicator system. The detection system may further include acquiring the electrical power by the indicator device using a radio frequency power receiver device operative to receive the transmitted radio frequency signals. Such acquired electrical power may be stored by the detection system in a rechargeable battery for use when needed by other electrical components in the detection system such as the indicator device, processor and mobile phone signal detection system.

It should be appreciated that mobile phones are operative to emit RF radiation which may cause medical conditions (e.g., cancer) in users of the mobile phones. In order to minimize such risk to the users of mobile phones, a further embodiment of a detection system may be in the form of a case, holster, or other carrier in which the mobile phone is carried. Such a carrier may be mountable to a person on a belt, or built into clothing and may include shielding in one or more locations on the housing which shield portions of the user's body from RF radiation emitted by the mobile phone. Such a carrier may include detection features therein which are operative to detect when an incoming call, text message or other notification is being received by the mobile phone. For example, the case may include a vibration sensor that is operative to detect when a mobile phone in the case vibrates and/or may include a microphone that is operative to detect when the mobile phone outputs its ringtone. The case may include a processor that is responsive to the vibration sensor and/or microphone to cause an output device (led light source, speaker) included in case to output its own notification signal which is visible and/or is hearable by the user wearing the carrier. Such a case or clothing may also include an antenna which is operative to provide reception/transmission of mobile phone signals between the mobile phone and a cell tower, but which is located on a portion of the case that is spaced apart from the user wearing the case.

Many of the embodiments described herein are directed to detection of a mobile phone, in order to reduce the use of a mobile phone. However, it should be appreciated that mobile phones may also be adapted to include features which may make it easier for a user to avoid using a mobile phone when it is unsafe to do so, and/or to include features which make a mobile phone more useful. For example, mobile phones may include voice recognition capabilities that are triggered via pressing a button on the mobile phone or that are triggered by lifting the mobile phone up (which is detected by an accelerometer). Once the button is activated or the phone is lifted up, the mobile phone may be placed in mode to use a built in microphone to capture voice communications from the user and to take one or more actions depending on the voice communications detected.

In order to make such capabilities of a mobile phone more useful, in an example embodiment such mobile phones may be adapted (via software/hardware) to continually monitor for predetermined signals (in addition to the previously described button press or lifting up of the phone) which triggers the mobile phone to begin capturing and evaluating voice communications with a microphone (either with a built in microphone or with a hands free microphone/headphone connected via Bluetooth to the mobile phone). Such a signal may include an incoming voice, text, or other communication to the mobile phone. Upon the detection of such a signal, a mobile phone may be adapted to begin monitoring for predetermined voice communications receivable via a microphone included in or connected to the mobile phone. Such predetermined voice communications may include verbal commands such as “DRIVING”, “MEETING”, or other predetermined voice communications.

In an example embodiment, the mobile phone may include a software application that correlates such predetermined verbal communication commands with specific actions to take. Such actions for example that may be correlated to the detected verbal communication command of “DRIVING” may include the mobile phone automatically responding back to the incoming voice call or text message with a predetermined answering machine type voice message or a text message reply such as “I am driving and will reply at a later time”. Similarly, an action correlated to the detected communication of “MEETING” may include the mobile phone automatically responding back to the incoming voice call or text message with a predetermined answering machine voice message or a text message reply such as “I am in a meeting and will reply at a later time”.

In this described example, it should be appreciated that the application responsible for taking actions responsive to predetermined verbal communications may be customizable as to both the verbal communication and the actions that are correlated therewith. For example, the application may be operative to enable a user via a setup menu to specify a plurality of different verbal communication commands via typing the text of the command into the setup menu and/or inputting the command via speaking the command into the microphone. In addition, for each specified command, the software application may be operative to enable the user to specify one or more actions. As discussed previously such actions may include a response message. For such actions the software application may enable a user to input a desired message for the reply via typing the message as text and/or speaking the message into the microphone.

However, it should be appreciated that the actions correlated to verbal communications may include any other actions capable of being carried out by the phone. For example, the actions may include the execution of function of another application on the mobile phone, and/or executing a recorded macro that causes the phone to carry out a plurality of different functions.

In addition, it should be appreciated that the detected signals (that trigger the mobile phone to begin monitoring verbal communications from a microphone) may include signals from external transmitters. For example, a vehicle may include a transmitter installed therein that emits a short range designated RF signal for which a mobile phone is specifically adapted to detect in order to trigger activation of the monitoring of verbal communications. In this embodiment, the mobile phone may require both the detection of the designated short range RF signal and another signal (e.g., the detection of an incoming phone call or text message) to cause the mobile phone to begin monitoring for the predetermined voice communication commands.

In an example embodiment, the RF transmitter device that is operative to emit the designated RF signal may be operatively configured to emit the designated RF signal when a vehicle is turned on. In further embodiments, the transmitter device may only emit the designated RF signal when the RF transmitter device determines that the car is moving (e.g. via an accelerometer, GPS, or a wired or wireless connection with a system in the vehicle that determines the velocity of the vehicle).

In an example embodiment, the designated RF signal may be a Bluetooth signal. However, it should be appreciated that in other embodiments, other types of RF signals may be used (e.g. NFC, WiFi). Also in other embodiments the transmitter may emit non-RF signals such as IR or any other type of signal capable of being detected by a mobile phone for purposes of trigger when to begin monitoring voice communications or carry out other actions.

In a further example embodiment, the RF signals that trigger the mobile phone to monitor for voice communications may correspond to triggering data included in a continuous stream of RF signals. In such embodiments, a software application operating on the mobile phone may monitor the RF signals for triggering data in or to determine when to trigger the detection of voice communications. For example, the described RF transmitter device may correspond to a Bluetooth transmitter plugged into the OBD port of a vehicle. Such a Bluetooth transmitter may communicate velocity information and/or other information such as diagnostic information acquired from a data store and/or a processor associated with the operation of the vehicle. The software application operating in the mobile phone may monitor such signals for data indicative of velocity above a predetermined threshold. When such velocity data is detected, the software application may be operative to cause the mobile phone to be in a mode that will trigger the detection of verbal communications via a built in or hands free microphone when an incoming voice call or text message is received. Also, when the software application detects velocity data that is below or equal to the predetermined threshold, the software application may cause the mobile phone to no longer be in the mode that triggers the detection of verbal communications via a microphone.

It should also be appreciated that the described software application operating in a mobile phone may be responsive to RF signals from transmitters mounted in other locations besides a vehicle. For example, in a home, office, or other environment, an RF transmitter may be placed in designated locations that may be useful to trigger when to begin detection of verbal communications. Such locations may include meeting rooms, church sanctuaries, and school class rooms for example.

In addition, it should be appreciated that an alternative embodiment of the described software application may be operative to place the mobile phone in a mode in which the mobile phone automatically responds to incoming voice and text messages with configurable reply messages without requiring a user to vocalize a verbal communication. For example, an office meeting room, church sanctuary, or school classroom may include a transmitter device operative to emit an RF signal detected by mobile phones in the respective room. Such a detected RF signal may cause the mobile phone to be in a mode which caused the mobile phone to automatically respond to incoming voice call or text message with a reply message indicating the user is unable to respond at the current time. The mobile phone may also be operative to cause the mobile phone to mute incoming message notification sounds and/or change to a vibrate mode responsive to the detected RF signal.

In this example, the RF signal may include data indicative of the type of room the transmitter is located (and/or other data), which can be used by the software application in the mobile phone to trigger a respective different action to take. Thus data in the RF signal indicative of a meeting room, may cause the mobile phone to reply to incoming voice calls with data indicative of the user being in a meeting, while not replying to text messages with such a message. Whereas RF signals indicative of a school class room, may cause the mobile phone to automatically reply to both incoming voice calls and text messages, that the user is unavailable at this time.

It should be appreciated that the described software application may be configurable to be responsive to RF signals, and data in RF signals to carrying any types of actions capable of being carried out by a mobile phone. Further it should be appreciated that the actions triggered may be further responsive to other actions (e.g., detection of voice communication commands and/or the detection of incoming voice calls and text messages, and/or any other signals and events) to carry out further actions (e.g., such as replying to incoming messages or other actions).

In additional, it should also be appreciated that the described software application may be used in combination with a home automation system that controls lights, stereos, TVs, heating and AC units, security systems, and other electronic components in a home or other building. For example, an RF transmitter device may be positioned in a home and may be operative to emit the previously described RF signal.

Also in a further embodiment, the RF transmitter may include a proximity detector (e.g., IR, ultrasonic, inductive). Such an RF transmitter may be responsive to detection of a user via the proximity detector to determine when to emit an RF signal to a mobile phone (rather than continuously emitting such a signal). Such an RF transmitter may be placed adjacent a doorway in such a position that movement of the door and/or the detection of a person adjacent the RF transmitter may cause the transmitter to emit the designated RF signal to the mobile phone. The mobile phone may then be responsive to the detected RF signal to switch to a mode to detect verbal communication and/or to automatically take an action which controls electronic components in the building.

For example, the mobile phone may be responsive to the detection of an RF signal to cause the mobile phone to begin monitoring for verbal communication commands. Such detected verbal communication commands may include “LIGHTS ON”, “LIGHTS OFF”, “SECURITY ON”, “SECURITY OFF” or other command that may be detected by the mobile phone and in response thereto cause lights, a security system, or other component to turn on or off. In order to control such components, the mobile phone may include a home automation application that interfaces via Wi-Fi or other wireless communication with a home automation system that controls the lights and/or other components of a building.

In addition, it should be appreciated that the described RF transmitters may include data in the RF signals which is used by the software application in the mobile phone to control applicable components in the building. For example, an RF transmitter near a front door may be operative to transmit data to the mobile phone indicative of the RF transmitter being near the front door. The software application operative in the phone may be responsive to such data in the RF signal to cause the home automation software to turn on/off the lights associated with a foyer near the front door, rather than lights in a remote part of the building. For this described embodiment, it should be appreciated that the software application may be configurable with respect to: different detected RF signals (and/or data included in the detected RF signals); one or more different detected verbal commands; and different configurable actions in order to control components in a building or other location via a mobile phone.

The described RF transmitter may be operative to emit RF signals to a mobile phone without requiring the RF transmitter to be paired with the mobile phone. (However, in some embodiments, the RF transmitter may be capable of carrying out a paring protocol (e.g. Bluetooth pairing) with one or more mobile phones. In addition, it should be appreciated that the described RF transmitter may be powered via an external or internal source. For example the described RF transmitter may be installed in a vehicle and may be powered via an electrical power line of the vehicle. However, it should be appreciated that in other embodiments the described RF transmitter may be powered via an internal battery. Further it should be appreciated that in a further embodiment the described RF transmitter may include a RF power receiver such as previously described herein for use with harvesting power from one or more RF signals and charging an internal rechargeable battery.

In addition, an example embodiment of the RF transmitter may include a processor and/or a data store/memory that is user programmable via a user interface included in the RF transmitter (e.g. buttons and/or a display device) in order to store and modify data that is transmitted from the RF transmitter to a mobile phone. Also, it should be appreciated that some embodiments of the RF transmitter may include an interface to a computer (e.g. via a USB port) that enables the RF transmitter to be connected to a computer for purposes of storing and/or modifying the data that is transmitted by the RF transmitter. Further, in alternative embodiments, the RF transmitter may include a wireless interface (e.g., via Bluetooth, NFC, Wi-Fi) that enables the RF transmitter to receive wireless signals operative to store and/or modify the data that is transmitted by the RF transmitter.

In addition, it should be appreciated that the described RF transmitter may correspond to a RF Transmitter and Receiver (i.e., an RF transceiver) capable of also receiving and detecting signals from a mobile phone. In this described embodiment, the RF transceiver may include features previously described with the detection system (and/or may correspond to the detection system for mobile phones). For example, the RF transceiver may be operative to detect a mobile phone and push a software application to the mobile phone (such as any of the previously described software applications for a mobile phone described herein). Also as previously described, the detection system features included in the described RF transceiver may be operative to prevent a vehicle or other equipment from caring out at least one feature (e.g., moving, operating) unless the RF receiver receives confirmation from the mobile phone that the mobile phone is operating a particular software application or has a particular feature that limits capabilities of the phone while operating the vehicle or equipment (e.g., limits talking on the mobile phone while driving or operating the equipment).

In a further embodiment (in which the detection system corresponds to and/or includes an application on a mobile phone) the system may be operative to modify communications sent from the mobile phone to indicate to a receiving party that the mobile phone is in a moving vehicle. As discussed with respect to other example embodiments, the detection system may be operative to use data acquired via the phone to determine that the phone is in motion in a moving vehicle. For example this determination could be made via, GPS data indicating velocity above a predetermined threshold; accelerometer data; and/or any other data acquired/received by the phone that indicates motion of the mobile phone indicative of being in a moving vehicle. In this example embodiment, when a user is communicating with a remote person via voice communications using his/her mobile phone, the described detection system (e.g., in the form of an application integrated into and/or installed on the phone) may be operative to include an audible warning signal along with the voice communications, responsive to the detection system determining that the mobile phone is in a moving vehicle.

Such an audible warning signal may correspond to a distinctive noise, tone, verbal message, and/or any other audible message or signal that expressly informs the remote person that they are conducting a conversation with a person that is using their mobile phone in a moving vehicle. For example, the audible message may take the form of a verbal message that states “TALKING WHILE DRIVING” (or other phrase) that is inserted/overlaid into the audible communication sent to the remote person's communication device. In another example, the audible message may take the form of sounds indicative of motion (e.g., engine sounds; the sounds of a passing high speed vehicle that illustrates a change in tone caused by the Doppler Effect; or any other sound that conveys speed, motion, movement).

In this described embodiment, such a message is operative to put the remote person on notice that the person they are communicating with may be operating the phone while driving. With such notice, the remote party can take appropriate actions, such as terminating the phone call before an accident occurs, for which they may be partially responsible (e.g., for distracting the driver) and for which they may be held liable for negligence.

In an example embodiment, the system may cause the mobile phone to add an audible message to the voice communication so that both the voice communication and the added audible message can be heard by both parties to the conversation. However, in alternative embodiments, the system may cause the mobile phone to temporarily interrupt the voice communication with the audible message so that generally only the audible message can be heard by both parties and not the voice communication. Also, in other embodiments, the system may cause the mobile phone to enable only the remote party to only hear the audible message. In further embodiments, the system may cause the mobile phone to enable the local party and remote party to hear different audible messages.

In another example, when a user is communicating with a remote person via text (e.g., SMS), communications using his/her mobile phone, the described detection system (in the form of an application integrated into the phone) may be operative to include text and/or graphical symbols in the text message, responsive to the detection system determining that the mobile phone is in a moving vehicle. Such added text/symbols may correspond to a visual message that expressly informs the remote person that they are receiving/responding to text messages with a person that is using their mobile phone in a moving vehicle. Such added text for example may take the form of a warning that the user may be driving (e.g. “SENT WHILE DRIVING”). Such an added symbol for example may take the form of a symbol such as a symbol that depicts a moving car.

Also it should be appreciated that the described detection system may be integrated into individual applications installed on the phone, e.g., a phone application, messaging application or any other application that communicates with a remote party. Also, for example, a game and/or a social media application (e.g. a Facebook application) may be adapted to include this described detection system, and may be operative to convey messages that provide information that indicates to remote parties that the user is communicating using the application on their mobile phone while in a moving vehicle.

As discussed previously with respect to the detection system that monitors a roadway (or other locations), one or more antennas may be mounted in and/or near the roadway (or other locations) in order to capture mobile phone signals from passing vehicles and/or persons using mobile phones. As discussed in previous embodiments, the antennas may also be mounted to vehicles (e.g. such as busses, trucks) that include the described detections systems mounted therein. However, it should be appreciated that in further embodiments, one or more antennas may be mounted to flying vehicles, such as balloons, blimps, airplanes, drones, and/or any other craft that moves and/or is stationary above the ground.

In an example embodiment, the detection systems mounted in the flying vehicles may be operative to send communications to law enforcement of the location of vehicles in which mobile phones are actively being used to send communications. Such communications from the flying vehicles to law enforcement may also include images/video of the detected vehicles captured by the detection systems (in the flying vehicles). Such communications from the flying vehicles to law enforcement may also include other data captured by the detection systems, such as mobile phone signals, velocity of the detected vehicle, and/or any other data capable of being captured/determined from the detected vehicle via sensors in the detection system. In example, embodiments, the flying vehicle may be operative to acquire sufficient mobile phone signals associated with a particular phone from different special locations in order to pinpoint and/or confirm that the detected mobile phone signal originated from a particular vehicle.

Law enforcement may include computer systems capable of receiving the communications from the flying detection systems (either directly and/or via a server that originally receives the communications from the flying detection systems). Law enforcement may use the communications from the flying detection systems to determine which vehicles to visually observe and corroborate use of a mobile phone by a driver in the vehicle, and/or to determine which vehicles to pull over to issue a citation/ticket.

In addition, it should be appreciated that such flying vehicle may be operated and directed to move by a human on the ground, and/or automation programming in the flying vehicle. Such programming in the flying vehicle may be configured to cause the flying vehicle to seek, find, and/or track vehicles with particular characteristics (e.g. a vehicle emitting mobile phone signals, or other detectable characteristic). The flying vehicles may also be operative to detect gases, temperatures, light bands, or any other emission from a vehicle or other object. Embodiments of the flying vehicle may be operative to detect RF signals or other emissions from other objects besides vehicles (such as buildings).

Also, in further embodiments the flying vehicle may be operative to function as a first responder to begin gathering and reporting information about highway accidents to police, firefighters, and EMS providers. In addition, the flying vehicle may be operative to collect data in a local drive inside the flying vehicle and/or may be operative to continually or periodically transmit collected data to remote transceivers and servers via WiFi signals, cellular signals, satellite signals, and/or any other RF or other wireless communication. Further, the data collected via the flying vehicles may be made available via a suitable server interface (e.g. a web portal or other API) to provide data mining of collected information for other users in government or private industry.

It should be appreciated many of the embodiments described herein are operative to detect RF signals from mobile phones and to determine which users (e.g. drivers) may be using such mobile phones. However, it should also be appreciated that these described features may be used in alternative embodiments in which a detection system is operative to detect whether users are associated with other types of RF signals. For example, in a school, prison, government building, or any other location, example embodiments of a detection system may be operative to detect RF signals such as from RFIDs. Such RFID may correspond to an RFID chip (passive or active) that is embedded in a badge, arm band, card, bracelet, or other article that is capable of being worn or carried by a user, or is embedding in a portion of a person's body.

As with previously described embodiments with respect to detecting which drivers in a roadway may be using a mobile phone, this described example detection system may be operative to detect which individuals in a particular space (hallway, room, or other location) are associated with RF signals of a particular predetermined type (e.g. RFID signals). In this example, the detection system may include other sensors to assist in the processor of the system corroborating that particular detected RFID signals are associated with particular individuals in the space being monitored. For example, other sensors may include one or more camera, motion detectors, movement detectors, presence sensors, velocity detectors, and/or any other type of sensor that can detect the physical location of individuals and/or track the movement and/or velocity of the individuals.

Also, as discussed previously with respect to other embodiments, the detection system may include two or more spaced apart antennas (mounted around the space being monitored) that are operative to be used by the detection system to monitor relative power levels of RFID signals, so as to calculate relative positions, motion, movement, and/or velocity of RFIDs present and/or moving in the monitored space. The processor of this described system may then compare the location/motion/movement/velocity information determined for the RFIDs from the RF signals to the location/motion/movement/velocity information determined from other sensors (e.g. cameras). Responsive to this comparison, the processor of the detection system may be operative to determine which individuals include RFIDs. The detection system may also be operative to process the RFID signals to detect information in the RFID signals (such as an ID number of person, badge, card, or other data that is usable to identify the individual carrying the RIFD).

In addition, in this described embodiment, the detection system may be operative to identify which individuals detected by the other sensors (e.g., the camera) which are not associated with a detected RFID signal. Such individuals may correspond to trespassers or other individuals who are not permitted in the monitored space without an RFID card or other RFID signal emitting article. The example detection system may be operative to report both individuals that are detected with RFIDs and individuals that are detected that are without RFIDs (or at least without RFIDs that are of the type that are being monitored by the detection system as being used to authorize individuals in the monitored space.) Such a server may be operative to collect data from one or more of these described detection systems. Upon receiving data indicative of an individual that does not include an appropriate RFID in a monitored pace, the server may be operative to issue warnings to one or more security individuals (e.g. via activating an alarm sirens, sending an SMS messages to a guard, and/or via causing another form of alarm to be outputted/communicated).

In a further embodiment, the RFID device carried by an individual may include or be in operative connection with a sensor that is operative to capture information from the environment around the person and/or capture information from the person carrying the RFID device. Such information may be reported by the RFID device through radio frequency signals to the detection system and to the remote server. An example of a sensor may include a multilevel sound sensor operative to detect different levels of sound. The RFID may be operative to include data representative of different levels of sound and/or types of sounds that are detected by the sensor in the RF signals transmitted from the device. Such different levels or types of sound capable of being detected by the sensor may include sounds indicative of shouting, gunshots, explosions, or any other sounds with a distinctive signature. In other embodiments, a sensor may be operative to monitor characteristics of the person carrying the RFID device such as the pulse, heartbeat, and temperature of the person, and report this information in RF signals to the detection system and remote server.

In the described embodiments, the system and method steps have been described as being carried out by various components of the described systems. Such components may include one or more computers and servers having processors that are operative to carry out the steps and features described herein responsive to firmware, software, and received and stored data. For example, the computer may be operative to acquire the data captured by one or more of the described cameras, mobile phone signal receiver devices, and other sensor devices and store the data from a detected event in a data store locally and/or remotely from the computer. Further, the computer may be operative to carry out the monitoring of acquired data to determine when to trigger events such as capturing images of a moving vehicle. Further, the computer may be operative to carry out correlating data from different devices to determine which vehicle on the road is the source of mobile phone signals. In addition, the computer may be operative to carry out signal analysis and/or image analysis on the information provided by the various detectors to achieve a more accurate determination of whether illegal mobile phone usage is taking place in a particular vehicle, building, or other location. Also, the computer may be operative to carry out wired and/or wireless communication of the acquired information to one or more remote locations, such as further computers and servers operative to review, report and/or evaluate the information captured and determined by the described system.

Computer executable software instructions used in operating the described systems and connected computers may be loaded from non-transitory computer readable media or articles of various types into the respective computers to cause processors to carry out the described methods herein. Such computer software may be included on and loaded from one or more articles such as compact disks, DVDs and other optical or magnetic media. Such software may also be included on articles such as hard disk drives, tapes, flash memory drives, SSDs, or other rewritable or read-only drives and storage devices. Other articles which include data representative of the instructions for operating computers in the manner described herein are suitable for use in achieving operation of the systems and methods in accordance with the described embodiments. These described articles on which software or firmware may be stored correspond to non-transitory computer readable media.

Thus the new mobile phone detection systems and methods described herein achieve one or more of the above stated aspects, eliminate difficulties encountered in the use of prior devices and systems, solve problems, and attain the desirable results described herein.

In the foregoing description, certain terms have been used for brevity, clarity and understanding; however, no unnecessary limitations are to be implied therefrom, because such terms are used for descriptive purposes and are intended to be broadly construed. Moreover, the descriptions and illustrations herein are by way of examples and the invention is not limited to the exact details shown and described.

It is noted that several examples have been provided for purposes of explanation. These examples are not to be construed as limiting the hereto-appended claims. Additionally, it may be recognized that the examples provided herein may be permutated while still falling under the scope of the claims.

In the following claims, any feature described as a means for performing a function shall be construed as encompassing any means known to those skilled in the art to be capable of performing the recited function, and shall not be limited to the features and structures shown herein or mere equivalents thereof. The description of the embodiment in the Abstract included herewith shall not be deemed to limit the invention to features described therein.

Having described the features, discoveries and principles of the invention, the manner in which it is constructed and operated, and the advantages and useful results attained; the new and useful structures, devices, elements, arrangements, parts, combinations, systems, equipment, operations, methods and relationships are set forth in the appended claims.

I claim:

1. An apparatus comprising:
a detection system, including at least one processor and a plurality of sensors that are operative to be used by the at least one processor to determine which individuals in a group of individuals are and are not transmitting a predetermined type of radio frequency signals, wherein the sensors include at least one radio frequency antenna operative to receive radio frequency signals from locations associated with positions of each respective individual, wherein the sensors include at least one further sensor that is operative to detect data that is used by the at least one processor to corroborate which individuals in the group are and are not transmitting the predetermined type of radio frequency signals, wherein the detection system is operative to communicate to at least one remote server, data corresponding to at least a portion of the determination made regarding which of the individuals in the group are and are not transmitting the predetermined type of radio frequency signals.

2. The apparatus according to claim 1, wherein the at least one further sensor includes at least one movement detection device, that is operative to determine data representative of movement associated with each of the individuals, wherein the at least one processor is operative to use the movement data to corroborate which individuals in the group are and are not transmitting the predetermined type of radio frequency signals.

3. The apparatus according to claim 2, wherein the movement detection device corresponds to a velocity detection device that is operative to determine at least one velocity associated with each of the individuals, wherein the at least one processor is operative to use velocity data determined through use of the velocity detection device to corroborate which individuals are and are not transmitting the predetermined type of radio frequency signals.

4. The apparatus according to claim 2 wherein the at least one further sensor includes a camera.

5. The apparatus according to claim 4, wherein the at least one detection system is operative to communicate to the at least one remote server, data corresponding to which of the individuals are not associated with the predetermined type of radio frequency signals.

6. The apparatus according to claim 4, wherein the detection system includes a portable hand-held portion, wherein at least the portable hand-held portion includes a camera, wherein the predetermined type of radio frequency signals corresponds to mobile phone signals, wherein the sensors are operative to be used by the at least one processor to determine that a mobile phone is actively being used in a moving vehicle by a user in the moving vehicle, wherein the at least one radio frequency antenna is operative to receive mobile phone signals from the mobile phone positioned in the vehicle.

7. The apparatus according to claim 6, wherein the detection system includes an IR illuminator that is operative to illuminate at least portions of the vehicle with IR illumination capable of being captured by the at least one camera.

8. The apparatus according to claim 6, further comprising eyewear, wherein the eyewear includes a display device mountable adjacent the eyes of an operator of the detection system, wherein the processor is operative to cause the display device of the eyewear to display at least one image captured by the at least one camera.

9. A method comprising:
a) through operation of at least one processor, capturing audio signals with at least one audio capture device responsive at least in part to a voice of a user talking on a mobile phone;
b) through operation of the at least one processor, causing a delayed auditory feedback (DAF) to be outputted through at least one audio output device that is audible to the user of the mobile phone, responsive at least in part to the audio signals captured in (a), wherein the at least one processor is operative to generate the DAF so as to include an audible sound signal representative of the voice of the user delayed by at least one predetermined amount of time relative to the actual voice of the user, which delayed at least one predetermined amount of time is controllable by the at least one processor.

10. The apparatus to claim 9, wherein (a) includes:
through operation of the at least one processor in a vehicle, capturing the audio signals with the at least one audio capture device responsive at least in part to the voice of the user talking on the mobile phone in a moving vehicle,
wherein in (b) includes:
through operation of the at least one processor, causing the delayed auditory feedback (DAF) to be outputted through the at least one audio output device that is audible to the driver in the vehicle, responsive at least in part to the audio signals captured in (a);
further comprising:
(c) subsequent to (b) through operation of the at least one processor, determining at least one velocity associated with the vehicle, wherein at least (b) is carried out responsive at least in part to the determined at least one velocity.

11. The apparatus according to claim 9, wherein the at least one processor is included in the mobile phone, wherein the mobile phone includes at least one application that is operative to cause the at least one processor to produce the DAF, wherein the application is operative to enable the at least one predetermined amount of time to be configured through operation of an input device included in the mobile phone, wherein the configurable at least one predetermined amount of time includes an amount of time that is between 10 ms and 100 ms.

12. An apparatus comprising a mobile phone including:
at least one processor;
an operating system operative in the at least one processor;
at least one communication device operative to enable the mobile phone to communicate through the Internet;
a plurality of applications executable through operation of the at least one processor, each operative to interface with the operating system to communicate with different respective remote servers accessible through a network,
wherein the operating system is operative to make a determination as to whether the mobile phone is moving,
wherein at least one of the plurality of applications is operative to individually query the operating system to determine whether the mobile phone is likely moving in a vehicle,
wherein responsive to the query, the operating system is operative to provide a response to the at least one application, which response includes information indicative of whether the mobile phone is moving in a vehicle,
wherein the at least one application is operatively configured to disable at least one feature of the at least one application from being usable by a user of the mobile phone, responsive at least in part to the response received from the operating system, when such response includes information indicative of the mobile phone moving in a vehicle,
wherein the at least one application is operatively configured to enable the at least one feature of the respective application to be usable by a user of the mobile phone, responsive to the response received from the operating system, when such response includes information not indicative of the mobile phone moving in a vehicle.

13. The apparatus according to claim 12, wherein the at least one application is operatively configured to cause the mobile phone to prompt a user to provide through at least one input device of the mobile phone a manual input representative of a confirmation that the user is not driving a vehicle, wherein the at least one application is operatively configured to enable the at least one feature of the respective application to be usable by a user of the mobile phone, responsive to receipt of the manual input through operation of the at least one input device of the mobile phone.

14. The apparatus according to claim 12, wherein the at least one application includes a social media application, which social media application enables a user to operate the mobile phone to receive communications from and to post communications to at least one remote server, which communication are accessible to a plurality of other users through operation of the least one remote server, wherein the social media application does not carry out voice communications or SMS messages with the at least one remote server.

15. An apparatus comprising a mobile phone including:
at least one processor;
at least one communication component that is operative to cause the mobile phone to transmit at least one communication to a remote mobile phone, wherein the at least one communication includes at least one of: a voice communication, a text message, or any combination thereof;
at least one global positioning system (GPS) device;
at least one application executable in the at least one processor, wherein the at least one application is operative responsive at least in part to data determined from the GPS device to cause the at least one communication component to include a message in the transmitted at least one communication, which message conveys information indicative of the communication being communicated from a mobile phone that was moving in vehicle.

16. The apparatus according to claim 15, wherein the at least one communication includes an SMS message, wherein the message included in the SMS message includes at least one of: text, a symbol, or any combination thereof which conveys that the SMS message was communicated from a mobile that was moving in a vehicle.

17. The apparatus according to claim 15, wherein the at least one communication includes a voice call, wherein the message included in the voice call includes a sound corresponding to at least one of: a verbal warning, a sound indicative of a warning, or any combination thereof, which warning audibly conveys that the voice call involves a mobile that is moving in a vehicle.

18. An apparatus comprising:
at least one mobile phone that is operative to detect an RF communication, wherein responsive at least in part to the detection of the RF communication, the at least one mobile phone is operative to change to a mode in which the mobile phone is operative to automatically respond to incoming voice calls or text messages with a reply message indicating the user is unable to respond at the current time.

19. The apparatus according to claim 18, wherein the mobile phone includes:
at least one processor;
at least one communication component that is operative to cause the mobile phone to transmit at least one communication to a remote mobile phone, wherein the at least one communication includes at least one of: a voice communication, an SMS message, or any combination thereof;
at least one application executable in the at least one processor, wherein the at least one application is operative responsive at least in part to the detection of the RF communication to cause the at least one communication component to respond to an incoming voice call or an SMS message with a reply message that conveys information indicative of the user not being available;
wherein, the at least one application is configurable to be operative to communicate different corresponding reply messages responsive to detected different RF communications from different RF transmitters; and
wherein the at least one application is operative to cause the mobile phone to mute incoming message notification sounds responsive at least in part to the detected RF communication.

20. An apparatus comprising:
at least one mobile phone including an application operative to execute in a processor of the mobile phone, wherein the at least one application is operative to determine a location of the mobile phone and enable a remote server to communicate an alert message to the mobile phone when the determined location of the mobile phone corresponds to a range of locations associated with the alert message stored in the remote server.
